(19) United States
(12) Patent Application Publication
(10) Pub. No.: US 2007/0029365 A1
(43) Pub. Date: Feb. 8, 2007

(54) High volume microlamination production of devices

(76) Inventors: Brian K. Paul, Corvallis, OR (US); Toni L. Doolen, Corvallis, OR (US); Christoph Pluess, Bern (CH); Nitin Sharma, Santa Clara, CA (US)

Correspondence Address: KLARQUIST SPARKMAN, LLP, 121 SW SALMON STREET, SUITE 1600, PORTLAND, OR, 97204, US

(21) Appl. No.: 10/576,963

(22) PCT Filed: Oct. 25, 2004
(86) PCT No.: PCT/US04/35452

§ 371 Date: Apr. 24, 2006

Related U.S. Application Data
(60) Provisional application No. 60/514,237, filed on Oct. 24, 2003.

(51) Int. Cl. A47J 36/02

(52) U.S. Cl. 228/101

(57) ABSTRACT

Embodiments of a differential thermal expansion bonding device are described for the high volume bonding of laminae together to form a MECS device. One embodiment of the device comprises a frame, engager made of a solid, liquid or gas, preload with springs and platens. Other embodiments of a method for bonding laminae together to form a MECS device using surface mount technology (SMT) techniques are described, with one embodiment being directed towards conveyorized bonding. The method including providing laminae to be bonded that do not include a solder mask, microething at least a portion of at least one lamina, applying solder paste to a microetched portion, and bonding the laminae together using the solder paste. A method for continuously bonding laminae also is described, such as by using a conveyorized furnace for applying heat to a workpiece functionally associated with the bonding device. The method can include forced convective heating, cooling or both, using inert gas flush. A method and fixture for registering laminae compatible with the differential thermal expansion bonding device by using integral compliant features is also described.

### CROSS REFERENCE TO RELATED APPLICATIONS

The present application claims from the benefit of prior pending U.S. provisional application No. 60/514,237, filed on Oct. 24, 2003, and is a continuation-in-part of pending U.S. patent application Ser. No. 10/803,502. Certain aspects of embodiments disclosed herein also are discussed in pending United States patent applications assigned to Oregon State University, including U.S. patent application Ser. No. 09/369,679, entitled “Microlamination Method for Making Devices,” and application Ser. Nos. 09/996,621, and 60/455,735, entitled “Method For Making Devices Having Intermetallic Structures And intermetallic Devices Made Thereby”. Each of these prior pending applications is incorporated herein by reference.

### FIELD

The present application discloses embodiments of a method for producing MECS-type devices, particularly using high volume microlamination processes, and devices made by the method.

### BACKGROUND

Recently, there has been a growing emphasis in manufacturing Microtechnology-based Energy and Chemical Systems (MECS). MECS Microsystems may be used to process bulk amounts of a fluid or fluids within distributed and portable energy, chemical and biological systems. One important feature of MECS devices is embedded, highly-parallel arrays of microchannels that accelerate heat and mass transfer in bulk fluids. Small characteristic sizes of microchannels provide the benefits of large surface-to-volume ratios, laminar flow conditions and the opportunity to operate at elevated pressures.

Existing Microsystems typically are produced using silicon microfabrication techniques, but MECS functionality require that they have the thermal, chemical and physical properties of more traditional engineering materials, such as polymers, metals or ceramics, some of which, for instance, are capable of working at high temperatures. Further, MECS system sizes dictate using more economical materials than single crystal silicon. Microlamination is one approach to building monolithic microsystems having embedded microfeatures using engineering materials.

Microlamination involves patterning, registering and bonding thin layers of material often referred to as laminae. As an example, diffusion bonding is commonly used to join metallic and ceramic structures within microlamination architectures. In diffusion bonding, solid materials are heated to a necessary bonding temperature and subjected to a sufficient bonding pressure and held at these temperature and pressure conditions for a period of time sufficient for bonding to occur by solid state diffusion of atoms across material surfaces.

Technical challenges are imposed by diffusion bonding of laminae into Microsystems, including small layer thicknesses and proper alignment of the laminae. The bonding pressure has to be distributed uniformly throughout the microchannel device to prevent poor bonding conditions, which could lead to fluid leakage. Furthermore, the transmission of bonding pressure should not cause the microchannels to warp or collapse. Therefore, it is important to understand not only how the bonding parameters affect the strength of the bond between the layers, but also to examine how the parameters affect the design features of the microsystem. This is true for any thermal bonding process.

Common bonding processes use hydraulic vacuum hot presses, which limit the maximum size of the microsystem because the pressure applied by typical vacuum hot presses become more non-uniform as the size of the microsystem increases. Furthermore, vacuum hot press bonding chambers are typically too small for bonding large substrates. However, vacuum hot presses with bonding areas (e.g. 10 inches by 10 inches) are available, but expensive and energy intensive. Heating and operating such enormous vacuum chambers significantly slows the process and makes the bonding process even more unattractive.

Additionally, because vacuum hot presses operate with a closed chamber system, they are not practical for the high volume production of Microsystems.

A possible alternative to vacuum hot presses would be hot isostatic pressing (HIP). The HIP process is rarely used in industry due to its high process costs. In general, using a HIP process for MECS production, particularly high volume production, will experience the same problems associated with high volume MECS production as with a hot vacuum press.

Based on the above, a device and method for high volume microlamination production of devices using diffusion bonding to bond large or small substrates is desirable.

Alternatively, in some cases, diffusion bonding techniques may be time consuming and may generally require high temperatures and pressures. High temperature and pressure may result in undesirable warpage and residual stresses in the produced devices, which can cause geometric variations and misalignment between laminae. These undesirable effects ultimately result poor bonding and leakage within the MECS device.

Another disadvantage to the proliferation of microlaminated devices using known techniques is the high cost of production. It would be advantageous to develop a process to produce microchannel arrays on a high volume basis to significantly reduce cost.

Therefore, a bonding architecture that facilitates high volume production of MECS devices at a lower cost, using lower bonding temperatures and pressures, and requiring less time also is desirable.

### SUMMARY

The present disclosure describes embodiments of a differential thermal expansion clamping unit for bonding laminae together. One embodiment of the unit includes a base plate, a top plate, an engager positioned between the base plate and top plate and a spring that is positioned between the base plate and the engager. Furthermore, this disclosed embodiment includes a load stage positioned between the engager and the spring with a fastener retaining the load stage and the spring to the base plate. The engager may be an expansion cylinder or fluid expander filled with a gas or liquid. The unit could also have multiple engagers. Additionally, platens can be positioned above and below the laminae to be bonded. In certain embodiments, an adjustable set screw is integrated into the top plate and is raised or lowered to define an initial gap setting.

A method for bonding laminae together to form a device is also described. One embodiment of the method includes providing a thermally assisted bonding device having at least one pressure regulating spring and bonding laminae together using the device. The device has a frame and an engager that is positioned between the bottom plate and the top plate. At least one pressure regulating spring is positioned between the bottom plate and the engager and the laminae are positioned between the pressure regulating spring and the engager. The method further includes continuously bonding workpieces using plural, thermally assisted bonding devices in a conveyorized furnace for applying heat to the laminae. Bonding includes heating the thermally assisted bonding device such that the heat causes the engager to expand relative to the top plate and bottom plate and at a given time after heating the engager engages both the top plate and laminae and a final bonding pressure stored in the spring is applied to laminae. Furthermore, forced convective heating, forced convective cooling, or both, using an inert gas flush, can be used to facilitate the heating and/or cooling of the laminae. The laminae are registered prior to bonding, and in one embodiment are thermally registered using a registration fixture prior to bonding laminae. The registration fixture can have flexible laminae engagement portions that flex when displaced by expanding laminae.

Another embodiment of a method for bonding laminae together to form a device is described. The embodiment includes providing a thermally assisted bonding device, positioning laminae within the device and continuously bonding laminae together using the device and a conveyorized heating system. Additionally, the laminae are stacked and registered using thermally assisted registration prior to bonding.

The present disclosure also describes a differential thermal expansion bonding fixture for bonding laminae together to form a device. The fixture has a base plate, a cylinder mounting plate having at least one, and typically plural, expansion cylinders and a pressure distribution plate positioned between the base plate and the cylinder mounting plate. The base plate and cylinder mounting plate are made from ceramic and the expansion cylinders are made from metal. The expansion cylinders may have different lengths, or the cylinder lengths in a particular embodiment may be adjustable, for differential application of pressure to workpiece or different coefficients of thermal expansion. Additionally, the expansion cylinders may be spring biased expansion cylinders with different spring constants.

A differential thermal expansion bonding device for bonding laminae together is described. The device has a frame with a base plate, two upright arms and an open top, and an engager positioned within the frame. When pressure is exerted on the arms via differential thermal expansion of the engager, the applied pressure has a horizontal pressure component and a vertical pressure component. Only the vertical pressure component is transferred to the laminae.

A thermally assisted registration device for registering laminae is described. The device has a flexible registration element and a bonding fixture. The flexible registration element is either removably attached to or integral with the bonding fixture and flexes upon contact with the laminae or integrated with the laminae and flexes upon contact with the bonding fixture.

A compliant thermally assisted registration method for registering laminae is disclosed. One embodiment involves taking a thermally assisted registration device having a flexible registration element that flexes when contacted by thermally expanding laminae and operatively associating laminae with the registration device. The laminae are then heated sufficiently to register the laminae.

Another compliant thermally assisted registration method for registering laminae is disclosed. This method involves providing at least one lamina having a flexible registration element that flexes upon contact by a thermal registration device and heating the laminae sufficiently to register the laminae.

The disclosure also describes a method for manufacturing a MECS device that includes forming a plurality of intermettalic laminae, registering the plurality of laminae using thermally assisted registration, and bonding the plurality of laminae together using a thermally assisted bonding device having a pressure regulating spring.

Finally, the disclosure describes a solder paste method for bonding laminae together to define a MECS device also is described. The method comprises providing laminae to be bonded that do not include a solder mask. At least a portion of at least one lamina is microetched in a bonding region selected to receive solder paste. Solder paste is applied to a microetched portion, and the laminae are then bonded together using the solder paste.

### BRIEF DESCRIPTION OF THE DRAWINGS

FIG. 1 is a schematic perspective exploded view illustrating an array of laminae that, when appropriately stacked, registered and bonded, collectively define a microfluidic device.

FIG. 2 is a perspective view of one embodiment of a thermally unconstrained pin alignment device.

FIG. 3 is a flow chart of a general process for MECS device fabrication.

FIG. 4 is a photograph providing a perspective view of one embodiment of a conveyer furnace, as provided by MRL Industries, California.

FIG. 5 is a schematic drawing illustrating production line assembly of MECS devices using thermal loading in a conveyorized furnace.

FIG. 6 is a schematic illustrating one embodiment of a disclosed differential thermal expansion bonding fixture.

FIG. 7 is a graph of temperature versus expansion illustrating the relationship between the thermal expansion of the frame and inner parts of the fixture of FIG. 6 as a function of temperature.

FIG. 8 is a graph illustrating a bonding cycle of one embodiment of a MECS device bonding process.

FIG. 9 is a schematic illustrating a differential thermal expansion bonding fixture of the present application.

FIG. 10 is a schematic illustrating one embodiment of a differential thermal expansion bonding fixture of the present application.

FIG. 11 is a graph illustrating a bonding cycle of a MECS device bonding process.

FIG. 12 is a schematic illustrating one embodiment of a differential thermal expansion bonding fixture of the present application.

FIG. 13a is a graph of stress versus strain illustrating pressure sensitivity as a function of temperature for the bonding fixture of FIG. 6.

FIG. 14 is a graph of stress versus expansion illustrating the pressure sensitivity as a function of temperature for the bonding fixture of FIG. 12.

FIG. 15 is a schematic illustrating one embodiment of a differential thermal expansion bonding fixture of the present application.

FIG. 16a is a perspective view of a working embodiment of a differential thermal expansion bonding fixture.

FIG. 16b is a perspective view of a working embodiment of a differential thermal expansion bonding fixture.

FIG. 17 is a perspective view of a load cell of the fixture of FIG. 16.

FIG. 18 is a perspective view of bonding platens of the fixture of FIG. 16.

FIG. 19 is a perspective view of a copper test substrate.

FIG. 20 is a graph illustrating fin warpage in a device formed with the fixture of FIG. 16 versus fin warpage in a device formed with a hot press.

FIG. 21 is a graph illustrating fin warpage in a device formed with the fixture of FIG. 16 at different pressures.

FIG. 22 is a graph illustrating fin warpage in a device formed with the fixture of FIG. 16 in relation to temperature and pressure.

FIG. 23 is a graph illustrating fin warpage in a device formed with the fixture of FIG. 16 versus fin warpage in a device formed with a hot press at different pressures.

FIG. 24 is a chart illustrating void fractions in a device formed with the fixture of FIG. 16 versus void fractions in a device formed with a hot press.

FIG. 25 is a graph illustrating the effects of the introduction of an inert gas during cooling of a device formed with the fixture of FIG. 16.

FIG. 26 is a perspective view of one embodiment of a differential thermal expansion bonding fixture for use with large substrates.

FIG. 27 is a cross-sectional side view of the fixture of FIG. 26.

FIG. 28 is a perspective view of one embodiment of a differential thermal expansion clamping unit used for bonding large substrates in a conveyor furnace.

FIG. 29 is an exploded view of the clamping unit illustrated in FIG. 28.

FIG. 30 is a schematic illustrating one embodiment of a differential thermal expansion bonding fixture of the present application.

FIG. 31 is a perspective view of an embodiment of a differential thermal expansion bonding fixture for use with large substrates.

FIG. 32 is a side view of the fixture of FIG. 31.

FIG. 33 is a cross-sectional side view of an embodiment of a differential thermal expansion clamping unit for use with large substrates.

FIG. 34 is an embodiment of a device using compliant features for laminae registration.

FIG. 35 illustrates using plural flexible wings, which engage alignment portions of the laminae.

FIG. 36a illustrates inclusion of integrated compliant features on individual rectangular-shaped laminae.

FIG. 36b illustrates inclusion of integrated compliant features on individual circular or rotational shaped lamina.

FIG. 37a illustrates inclusion of embedded compliant features on individual prismatic or planar laminae.

FIG. 37b illustrates inclusion of embedded compliant features on individual circularly shaped laminae.

FIG. 38 compares costs associated with producing microchannel arrays using surface mount technology compared to diffusion bonding.

FIG. 39 illustrates a geometry formed by patterning, for example stamping and forming, that can eliminate the use of external channels.

FIG. 40 is a top view illustrating a stencil used in the application of solder paste onto laminae.

FIG. 41a is a top view illustrating printed solder paste on a spacer laming FIG. 41b is a top view illustrating printed solder paste on an end cap lamina.

FIG. 42 illustrates one embodiment of a method for stacking lamina with printed solder.

FIG. 43a is a top view illustrating an interface plate lamina geometry.

FIG. 43b is a top view illustrating a spacer/channel lamina geometry.

FIG. 43c is a top view illustrating a bottom end cap lamina geometry.

FIG. 44 is an exploded perspective view of a laminae arrangement forming a test device.

FIG. 45 is a table showing the values used for calculating a theoretical channel height.

FIG. 46 is a chart showing the values for channel height deviation for three test devices.

FIG. 47 is photomicrograph cross section illustrating 42:1 aspect ratio microchannels (336 microns channel height) formed by a spacer between two fins (25× magnification).

FIG. 48 is a photomicrograph cross section illustrating 42:1 aspect ratio microchannels showing spacer bonding to two fins using solder paste printed with a 0.012 inch stencil (50× magnification).

FIG. 49 is a photomicrograph cross section illustrating 42:1 aspect ratio microchannels showing solder bonds adjacent the microchannels (50× magnification).

FIG. 50 illustrates a set of prebonded substructures.

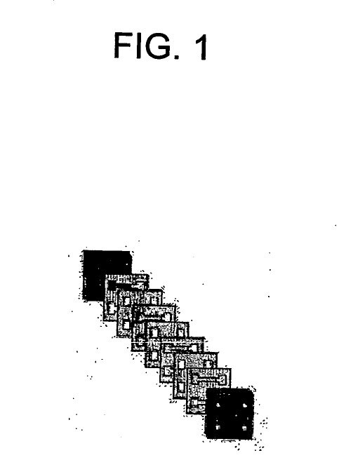

### DETAILED DESCRIPTION

### A. Microlamination Using Thermal Bonding and SMT

Microlamination involves forming a monolithic device by lamina patterning, lamina registration and lamina bonding. Patterning can be accomplished, for example, by laser ablation and/or evaporation with a laser micromachining system, such as an Nd:YAG micromachining laser system. Certain features of the laminae, such as microchannels, can be quite small, and at least as small as 100 microns.

Laminae with embedded microfeatures are stacked together. The 2D-microchannel architecture of single layers results in a 3D-microchannel arrangement when the appropriate laminae are properly stacked and registered. Registering or registration generally refers to orienting and/or aligning two or more objects, such as laminae, or features on adjacent lamina, such as apertures, channels, etc. with respect to one another.

Proper alignment and registration of the laminae are important considerations. Misalignment of the layers can cause channels to collapse and results in a poor bonding quality, which finally leads to device malfunction. Consequently, different approaches for properly aligning laminae have been developed. The registration approach depends on the geometry, size and total number of laminae. Registration may be accomplished mechanically using a registration jig. Alternative methods of registering the laminae include, but are not limited to, an interferometer utilizing laser, ultrasound, light, microwave, or other wave source, alignment tools utilizing one or more of mechanical, electrical, electromagnetic, acoustic, and particle beam techniques, and combinations thereof.

The design and development of a thermal bonding microlamination fixture can utilize thermal expansion during the bonding cycle. A possible approach is to use thermal expansion to self-align the laminae in a fixture using thermally enhanced edge registration (TEER). The TEER technique involves loading laminae into a fixture made of material with a lower coefficient of thermal expansion (CTE) than the lamina material. At room temperature, a clearance allowance exists between the laminae and the registration slot of the clamp to facilitate loading of the laminae into the fixture. At bonding temperature, the laminae contact the edge of the slot and a registration force is applied as the laminae expand that precisely aligns the laminae. This approach is preferable when assembling large numbers of lamina, e.g. approximately 5 or more, and provides satisfactory results, particularly for rectangular shaped laminae. Process and material variables, such as tolerances in the lamina patterning process (laser micromachining), and differences in the CTE of the different layers (unequal material quality), can result in variations of the bonding quality.

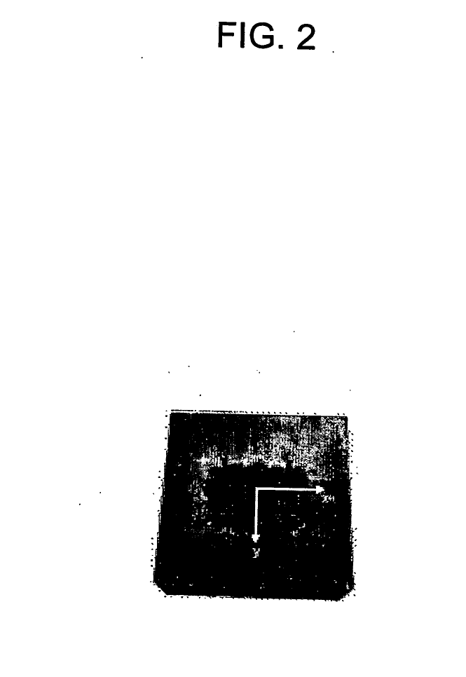

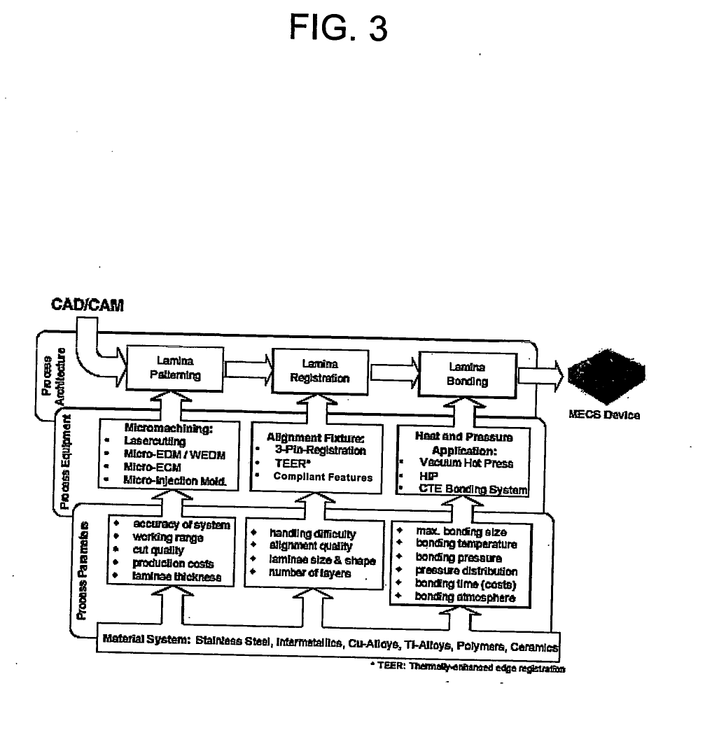

One embodiment of a device for aligning a small number of lamina, e.g. approximately less than five, using a fixture having a thermally unconstrained pin alignment base plate in a low-volume production mode is shown in FIG. 2. The plate can include plural alignment pins, with the illustrated embodiment including three pins. With three pins, such as tungsten pins, the laminae are positioned precisely on the planar surface of the plate by pushing the laminae against the pins. The pin alignment base plate can be closed with the counter part of the thermal bonding fixture. Due to the unconstrained pin alignment, the laminae can expand in both x- and y-directions during the bonding cycle.

Regardless of the registration process, state of the art diffusion bonding or surface mount technology (SMT) bonding of microlaminated devices currently does not allow economical, high volume MECS production. The closed chamber construction of standard vacuum hot presses limits the substrate size of the device, and concomitantly possible application performance and efficiency of the device. It is very difficult with a hydraulic ram press to apply a uniform pressure, especially for large substrates. The necessary equipment is expensive and power intensive. Furthermore, the whole bonding cycle with a closed chamber vacuum hot press is time consuming, especially during the cool down phase. The actual bonding time with a standard vacuum hot press during a bonding cycle varies between 20% to 60% depending on the material system. 40% to 80% of the production time for a microlaminated device is attributable to set up times and cool down phases of the vacuum hot press. Similarly, the use of SMT techniques for bonding microlaminated devices has not yet been achieved.

### B. New Approach for High Volume Production

As mentioned earlier, the microlamination process consists mainly of three steps: lamina patterning, lamina registration and lamina bonding. Process equipment and different process factors are associated with the three main production steps.

The three main proven steps used to produce MECS devices will remain regardless of the production volume. To progress from prototype production to high volume production, process equipment and process factors associated with the current process chain have to be adapted. An important factor, which influences each production stage, is the type of material being processed. The type of material used for a particular MECS device dictates the application of the micromachining equipment for the forming process, and sets process parameters for the bonding cycle, such as bonding temperature, pressure and time. Therefore, a new production approach has to consider the requirements for different material systems.

Furthermore, there will be an increasing demand for larger MECS devices. Larger MECS devices typically require larger substrates. Because laminae size influences the production process and the size of the necessary process equipment, the new production approach should be capable of processing large substrates, for example substrates with a 3 in. diameter square substrates up to at least 8.0 inches by 8.0 inches and non-square substrates having an area up to at least 64 in². However, production approaches described herein should also be able to process substrates having much larger sizes, for example, 1 meter by about 1 meter or an area of about 1 m², more typically about 24 inches by 24 inches or an area of about 576 in².

Improvements in the process chain have to be developed for laminae bonding by introducing a new method of bonding using continuous material flow. The following points have to be considered in the conceptual design of a new approach for the high volume production of MECS devices:

1. Flexible processing of different substrate sizes up to at least 24.0 inches by 24 inches or 576 in². (large substrates);

2. Continuous operation of a furnace without start-up and shut-down phases;

3. Innovative fixture design for simple and fast loading of laminae;

4. Accelerated cool down phase for fast removal of bonded devices;

5. Process simplification, lower costs due to high volume production and energy efficiency; and

6. Improved process and quality control.

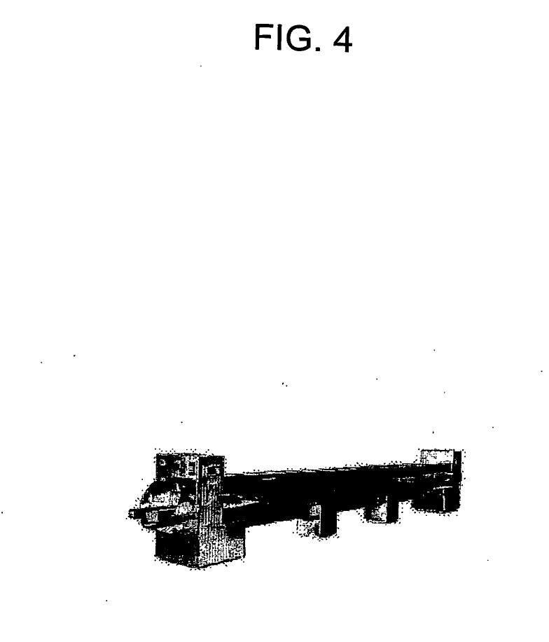

High volume production is facilitated by continuous processing of substrates. A bonding approach must be found which makes a “conveyorized” heat treatment possible. MRL Industries¹, a manufacturer of thermal processing equipment, fabricates conveyor furnaces (see FIG. 4, for example) that make continuous material flow possible. One problem is application of the bonding pressure and laminae registration.
¹ MRL Industries, Inc. http://www.mrlind.com

Bonding and registration due to differential thermal expansion as well as through SMT techniques can be applied to high volume production of MECS devices. A differential thermal expansion unit with lamina loaded thereon could be placed on the furnace conveyor, and the necessary bonding pressure and temperature applied in a heating zone. Bonding time would be controlled by the conveyor speed. Several embodiments of thermal clamping units for mass producing MECS devices are discussed below followed by a description of embodiments using SMT techniques for mass producing MECS devices.

### C. Production Line

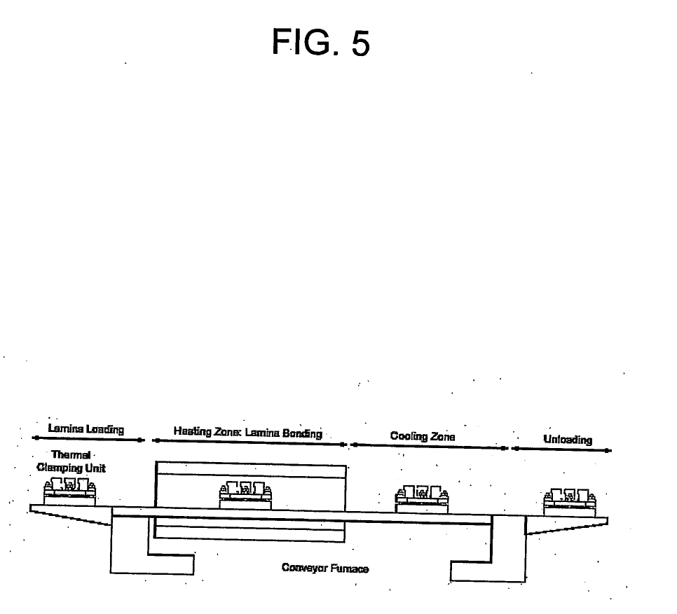

FIG. 5 illustrates one embodiment of a production line process for making MECS devices using a differential thermal expansion clamping unit. The first stage in the production line shown in FIG. 5 is loading the laminae into the clamping unit. The loaded unit is placed on the furnace conveyor and the bonding cycle starts. In the heating zone the differential thermal expansion clamping unit and the laminae are heated to bonding temperature. The clamping unit is configured so that at the bonding temperature the resultant pressure due to thermal expansion of the expansion cylinders is appropriate to bond together device portions or components made from the material being processed. Partial controllable heating zones of the furnace could provide better process control, e.g. faster unit heating.

While FIG. 5 illustrates a production line for differential thermal expansion bonding units, a similar production line for units using SMT techniques can also be used. Furthermore, a production line for bonding microlaminated devices can be implemented to use both differential thermal expansion and SMT techniques. For example, in one embodiment, portions of microlaminated devices can be first diffusion bonded in a conveyor furnace at a high temperature using differential thermal expansion bonding fixtures. The portions can then be bonded together in a conveyor furnace at a lower temperature to produce a completed microlaminated device using SMT techniques. In some embodiments, the portions are modular having identical structure. For example, four 500 Watt cooling devices can be separately manufactured using a differential thermal expansion bonding fixture and subsequently bonded to each other using SMT techniques to form a 2,000 Watt cooling device. In other embodiments, a single device has multiple structures each made of a stack of laminae, where some structures are diffusion bonded using a differential thermal expansion bonding fixture and other structures are bonded using SMT techniques.

### D. Differential Thermal Expansion Bonding Fixture Embodiment

Reduced production time in the bonding cycle is facilitated by a cooling gas, such as in reducing the cool down phase. One possible approach is to flush the clamping unit with an inert gas, examples of which include, without limitation, nitrogen, helium and combinations thereof, in the cooling zone of the production line. The bonded device is unloaded and the clamping unit is reset for the next microlamination procedure.

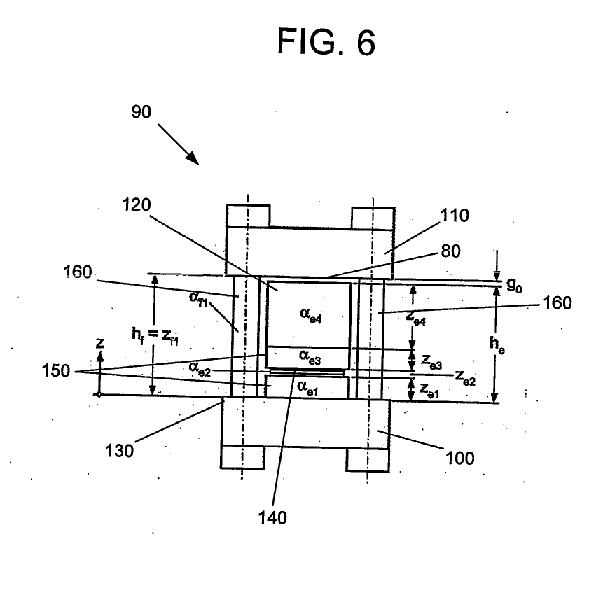

One embodiment of a bonding fixture based on the principle of thermal expansion for the application of bonding pressure is shown in FIG. 6. The bonding fixture 90 consists of a frame 130 having a bottom plate 100, a top plate 110 and frame posts 160. The fixture 90 includes an engager 120 interposed between bottom plate 100 and top plate 110, where the engager can be, but is not limited to, an engagement block, an expansion cylinder, a fluid expander or any combination thereof. The bottom and top plates, structurally connected by frame posts 160, represent a rigid frame 130. In one embodiment, the frame posts 160 are adjustable for adjusting the height of the frame. The engager 120 has a higher coefficient of thermal expansion than the frame 130 of the fixture 90. The coefficients of thermal expansion (CTE) should preferably differ at least by a factor of two. Generally, the height of the engager 120 is directly proportional to the amount of clamping pressure to be delivered. The laminae 140 are placed and aligned between the engager and the bottom plate. Preferably, the laminae 140 are placed between bonding platens 150. When the bonding fixture 90 is heated to the bonding temperature (T_{B}), the engager 120 and the platens 150 inside the frame expand relative to the frame by the difference in the sum of their coefficients of thermal expansion multiplied by the product of the height of the engager/platens and the change in temperature. An initial gap (g₀) can be designed into the fixture assembly to scale and time the application of the bonding pressure. As soon as the volume of the initial gap is occupied as the engager and platens expand due to the differential expansion behavior, e.g., when top plate of the frame and inner parts come into contact, compression is applied to the laminae. The compression force increasing with increasing temperature.

The thermal expansion (ΔLₜₕₑᵣₘₐₗ) of the individual fixture parts is determined by multiplying the part length (L) times the coefficient of thermal expansion (α) of the part times the change in temperature (ΔT) according to Equation 1.
ΔLₜₕₑᵣₑₘₐₗ=L·α·(T₂−T₁)=L·α·ΔT (1)

As the temperature increases from room temperature (T_{R}) to bonding temperature (T_{B}), the frame 130 and inner components 120, 140 and 150 of the fixture expand a distance (Δz), which, as expressed in equations 2 and 3, is equal to the sum of the coefficient of thermal expansion multiplied by the individual part height (z) for each part times the change in temperature. More specifically, equations 2 and 3 express the thermal expansion function of the fixture frame 130 (subscript f) and the inner components 120, 140 and 150 (subscript e).
Δz_{f}(T)=Σα_{f,i}·z_{f,i}·(T−T_{R}) (2)
Δzₑ(T)=Σα_{e,i}·z_{e,i}·(T−T_{R}) (3)

Since the inner components 120, 140 and 150 are designed to have a higher expansion rate, the initial gap (g₀) will close as a function of temperature by the difference of Equations 2 and 3 and can be expressed according to Equation 4.
g(T)=g₀−Δz(T)=g₀−(εα_{e,i}·z_{e,i}−εα_{f,i}·z_{f,i})·(T−T_{R}) (4)

It is of particular interest to set the initial gap (g₀) such that contact between the inner platens and the frame is reached at a certain temperature. The contact temperature (T_{C}) is defined as the temperature at which the initial gap has been reduced to zero.
g(T_{C})=g₀−(Σα_{e,i}·z_{e,i}−Σα_{f,i}·z_{f,i})·(T_{C}−T_{R})=0 (5)

Since the contact temperature (T_{C}) is unknown, it is useful to express it as a function of the known bonding temperature (T_{B}). The specification of the temperature difference (ΔT_{CB}) between contact and bonding temperature is actually responsible for the transfer of thermal expansion to structural strain and can be used for the scaling of the bonding pressure.
T_{C}=T_{B}−ΔT_{CB} (6)

Preferably, the temperature difference (ΔT_{CB}) should be as small as possible to prevent any possibility of fin warpage. Prevention of fin warpage is generally achieved if the temperature difference (ΔT_{CB}) is less than a critical temperature difference (ΔT_{crit}).

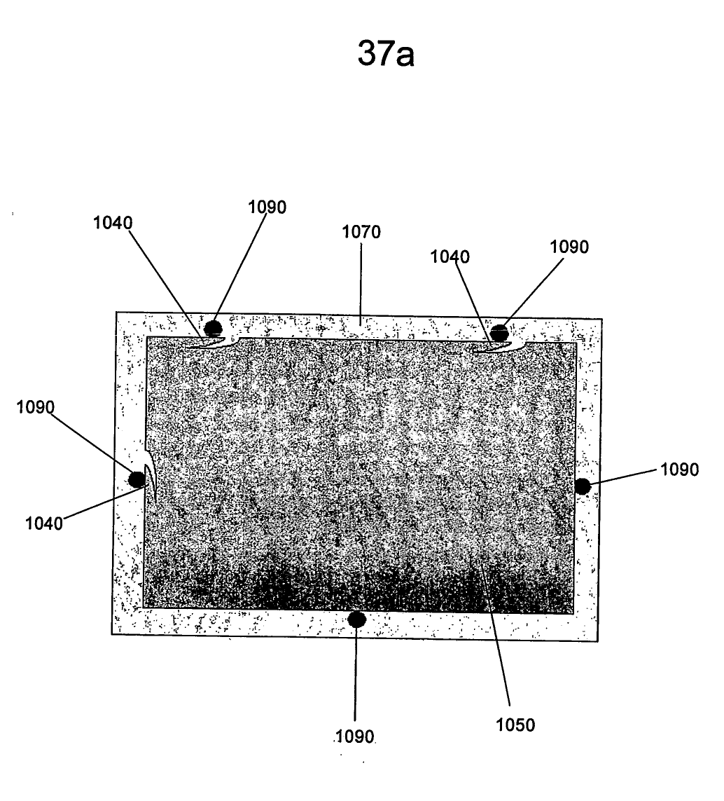

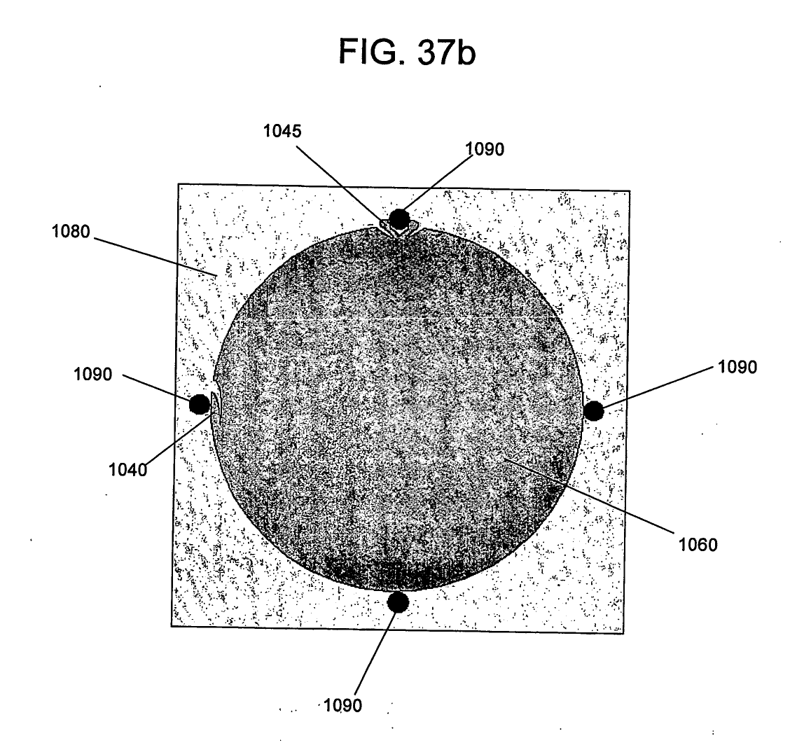

To determine if a channel fin will buckle, the mode of failure needs to be confirmed by calculating the critical buckling stress (σ_{C}). The fin buckling can be treated as column buckling since the fin cross-section (A) and the moment of inertia (I) are constant. As soon as the contact between the inner parts and the fixture frame is established, pressure will be transmitted to the laminae stack and the mode shape of fin buckling is derived from fixed-ended support condition as shown in FIG. 37.

For the fixed-ended boundary condition, the critical buckling stress can be calculated according to Equation 7, where P_{C} is the critical buckling load, A the area of the fin cross-section, L the length of the fin, S the fin span, E the elastic modulus of the lamina material and I the moment of inertia of the fin cross-section.

$${σ}_{C} = \frac{{P}_{C}}{A} = \frac{4 \cdot {π}^{2} \cdot E \cdot I}{A \cdot {S}^{2}} \qquad ( 7 )$$

As soon as pressure is applied to the laminae stack, frictional forces between the fixture platens and the laminae restrain thermal expansion of the laminae during a temperature rise. If the laminae expand faster than the fixture material, the pressurized laminae stack becomes constrained by the lower CTE of the fixture material (α_{fix}). However, the fin layers between tend to expand more freely at about the CTE of the laminae (αₗₐₘ). Thus, a buckling load will build-up and the force due to differential thermal expansion (P_{CTE}) during a temperature rise (ΔT) can be expressed as shown in Equation 8.
P_{CTE}=A·E·(αₗₐₘ−α_{fix})·ΔT (8)

If the load due to differential thermal expansion exceeds the critical buckling load (P_{CTE}≧P_{C}), the fin will buckle. Therefore, the critical temperature difference is solved by setting the loads equal as shown in Equation 9.

$$Δ {T}_{crit} \geq \frac{4 \cdot {π}^{2} \cdot I}{A \cdot {S}^{2} \cdot ( {α}_{lam} - {α}_{fix} )} \qquad ( 9 )$$

The cross-sectional area of the fin is given by Equation 10 and the moment of inertia for the fin can be expressed according to Equation 11.

$$\begin{matrix}A = t \cdot L & ( 10 ) \\ I = \frac{1}{12} L \cdot {t}^{3} & ( 11 )\end{matrix}$$

Introducing Equations 10 and 11 into Equation 9 simplifies the critical temperature difference to Equation 12.

$$Δ {T}_{crit} \geq \frac{{π}^{2} \cdot {t}^{2}}{3 \cdot {S}^{2} \cdot ( {α}_{lam} - {α}_{fix} )} \qquad ( 12 )$$

Equation 12 shows, that the lamina thickness (t), the fin span (S) and the involved CTE's have an influence on fin buckling. The calculation of the critical temperature can now be used to express the temperature difference between the contact and the bonding temperature of the ΔCTE-fixture. If the temperature difference ΔT_{CB} is smaller than the critical temperature difference ΔT_{crit} (ΔT_{CB}<ΔT_{crit}), fin warpage will be prevented. Hence, the contact temperature can be expressed as a function of the buckling limit as shown in Equation 13.
T_{C}=T_{B}−ΔT_{crit} (13)

By introducing Equation 13 into Equation 12 the initial gap can be calculated according to Equation 14.
g₀=(τα_{e,i}·z_{e,i}·−Σα_{f,i}·z_{f,i})·(T_{B}−ΔT_{CB}−T_{R}) (14)

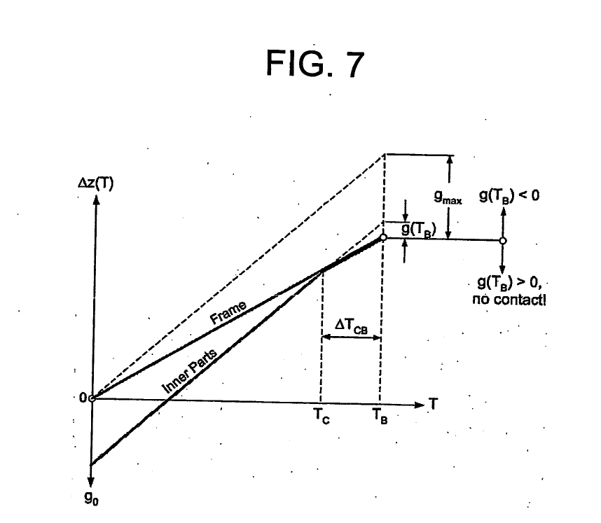

After defining the initial gap (g₀), the final amount of thermal expansion at bonding temperature g(T_{B}) can be calculated by using Equation 4. Since the higher expanding inner parts of the fixture will follow the expansion behavior of the more rigid frame after the contact temperature (T_{C}), the value of g(T_{B}) will be negative, which is indicative of the amount of compression within the fixture frame above T_{C} (see FIG. 7). This behavior is true for a stiff and rigid fixture frame construction.

The amount of compression in the laminae at the final bonding temperature can be expressed as the total compressive strain (εₜₒₜₐₗ) on the laminae with respect to the expanded frame height, h_{f}+Δz_{f}(T_{B}) as shown in Equation 15.

$${ɛ}_{total} = \frac{g ( {T}_{B} )}{{h}_{f} + Δ {z}_{f} ( {T}_{B} )} \qquad ( 15 )$$

To calculate the final bonding pressure, stress-strain relations have to be applied. In this simplified theoretical model the assumption was made that the modulus of elasticity of the individual parts are similar. From Equation 15 the resulting bonding pressure can be extracted by multiplying the amount of strain by the specific modulus of elasticity of the lamina material.
σₗₐₘ=εₜₒₜₐₗ·Eₗₐₘ (16)

Applying the equations above to the fixture design shown in FIG. 6, a sensitivity analysis of the bonding pressure was made. Pressure sensitivity being the amount a resultant bonding pressure may vary from a desired bonding pressure. If the sensitivity of pressure varies widely for small variations due to various process parameters, such as gap height adjustment inaccuracies and final bonding temperature fluctuations, then process control is difficult to establish. In this exemplary embodiment, the bonding platens 150 were made out of graphite (αₑ₁=αₑ₃=4.6 μm° C.) and had thicknesses of zₑ₁=zₑ₃=15 mm. A copper laminae stack (αₑ₂=24.8 μm/m° C.) was chosen as a substrate material with a stack height of zₑ₂=1 mm. The engager 120 was made of stainless steel 321 (αₑ₄=20.5 μm/m° C.) and had an initial height of zₑ₄=40 mm. The summation of all inner component heights gives a total height of the inner components of hₑ=71 mm.

A diffusion bonding cycle with a bonding temperature of 800° C. was assumed with a realistically defined temperature difference (ΔT_{CB}) of 25° C. between the contact and bonding temperature. The frame 130 was made of a ceramic material having a thermal expansion coefficient of 5.2 μm/m° C. and the frame height is given by h_{f}=hₑ+g₀. Introducing this relationship into Equation 14, the initial gap size (g₀) can be calculated to be 462 μm. These settings would result in inner components 120, 140 and 150 expanding 15 μm after the initial gap size is reduced to zero, consequently applying a calculated resultant pressure on the laminae of 23.4 MPa This pressure is well beyond a desired bonding pressure of about 5 MPa and preferably should be reduced.

The resultant pressure can be reduced in a number of ways. For example, the pressure can be reduced either by increasing the initial gap size or by changing geometry and material properties of the fixture design. By increasing the gap size to 474 μm, contact between frame and inner parts will be established 5° C. before reaching the bonding temperature. The temperature difference (ΔT_{CB}) of 5° C. reduces the interference to 3 μm and a resultant pressure of 4.7 MPa can be produced. Accordingly, an increase of 12 μm in initial gap size (g₀) reduces the pressure from 23.4 MPa to 4.7 MPa, i.e., changing the gap size ±1 μm varies the resulting bonding pressure by ±1.6 MPa. Since the initial gap was adjusted manually with a feeler gauge, a gap adjustment accuracy no better than ±5 μm was obtained in this embodiment, typically about ±10. Consequently, assuming all other possible sources of error are zero, the resultant pressure on the laminae when using the fixture design according to FIG. 6 has a minimum sensitivity of ±8.0 MPa, i.e., ±5×±1.6 MPa, due to gap adjustment inaccuracies and, as discussed above, resultant pressure sensitivity based on temperature differences of ±5° C. is ±4.7 MPa Therefore, neither initial gap adjustments nor temperature differences can be accurately controlled in order to achieve an acceptable pressure variation, which typically is in the range of ±0.5 MPa.

Another possible method for reducing the pressure sensitivity of the fixture illustrated in FIG. 6 is to reduce the product of the CTE and/or the height of the engager. Reducing either the height, CTE or both would decrease the pressure generation potential. For example, reducing the engager height from 40 mm to 20 mm and applying the same calculation as above, a bonding pressure of 6.6 MPa is achieved with an initial gap adjustment of 236 μm, which relates to a temperature difference (ΔT_{CB}) of 10° C. Using the same engager height but decreasing the gap to 231 μm, contact would be established 25° C. before reaching the bonding temperature with a resulting pressure of 16.4 MPa on the laminae stack (23.4 MPa for same ΔT_{CB} with zₑ₄=40 mm). In other words, changing the gap size by ±1 μg/m results in a pressure sensitivity of ±2.0 MPa, which is greater than the sensitivity when using the longer engager. In contrast, the pressure sensitivity caused by temperature fluctuations decreased with the shorter engager to ±0.65 MPa/° C. Therefore, decreasing the height of the engager while decreasing the pressure sensitivity caused by temperature fluctuations, nevertheless increased the geometrical sensitivity associated with the initial gap adjustment.

Based on the foregoing analysis conducted with the embodiment illustrated by FIG. 6, it can be concluded that the application of pressure due to thermal expansion of solid materials is highly sensitive. Obtaining a desired bonding pressure depends on process conditions and geometrical adjustments. Deviations for a desired bonding pressure can be due to temperature fluctuations or gap size adjustment inaccuracies. Gap size adjustments cause a larger pressure sensitivity than temperature fluctuation. To minimize pressure sensitivity associated with initial gap settings, the differential expansion rate of the fixture should be large, in other words, the engagers needs to be longer. Conversely, a longer engager increases the pressure sensitivity due to temperature fluctuations. Because minimizing pressure sensitivity caused by increasing the engager height also results in increased pressure sensitivity resulting from temperature fluctuations, pressure sensitivity reduction is effectively negated. Therefore, the above approach to reducing the pressure sensitivity of the fixture embodiment illustrated in FIG. 6 may not be effective with certain microlamination applications and a fixture design that is more effective in reducing bonding pressure may be desired.

### E. Alternative Differential Thermal Expansion Bonding Fixture Embodiments

The following disclosed embodiments provide advantages over the embodiment shown in FIG. 6 by effectively reducing pressure sensitivity for small and large substrates.

### 1. Useful Materials for Making Fixture Embodiments

Prior to discussing particular structures of alternative fixture embodiments disclosed by the present application, it is necessary to discuss materials useful for making such fixtures.

Joining polymer substrates is not as problematic as it is for designing fixtures that must be capable of providing functionality up to temperatures of around 1,000° C. for solid state diffusion bonding, of substrates made from metals, alloys and combinations thereof. The selection of useful materials can be based on several factors including the maximal service temperature of the material, the strength at service temperature, the coefficient of thermal expansion, manufacturability and cost of the material. Subsequently, the materials can be classified according to their CTE either for use as a material for the fixture frame or as a material for parts where higher thermal expansion is desired, such as the engager and/or platens.

The combination of materials contacting each other during the bonding cycle should be considered when selecting fixture materials. Substrate layers should be sandwiched between materials where no bond occurs in order to prevent the fixture from joining together. Finding satisfactory materials for the fixture design which can resist high temperatures, such as temperatures up to 1,000° C., without bonding to the substrate has proven to be difficult. Graphite is one example of a material useful for making high temperature fixtures. But, carbon particles from the graphite may diffuse into the substrate at elevated temperatures, thereby potentially changing the chemical and physical properties of the contacting laminae.

A non-reactive, high temperature alternative to graphite is ceramic. Many ceramic materials are machinable and can be fired to full stiffness. Like all brittle materials, ceramics preferably should be used for structural parts with static pressure loads. Another favorable attribute of ceramics is the low coefficient of thermal expansion.

As another alternative, contacting fixture parts can be coated with a ceramic material, such as yttria, silicon nitride, or other oxide or nitride, or combinations thereof to prevent solid state diffusion. These materials can be applied by first forming a slurry and then dipping or spray coating components with the slurry.

### 2. Disclosed Embodiments of the Present Application

Embodiments of a differential thermal expansion fixture can be divided mainly into a frame construction with a lower thermal expansion behavior, and inner parts inside the frame with a higher thermal expansion behavior. Both the frame and inner components generally are rigidly designed to substantially prevent deformations and deflections since the useable amount of thermal expansion generally will be in the range of 500±200 μm.

The fixture or thermal clamping unit can be adjusted for use with different material systems. Different materials need different pressures to register and bond and have different CTEs. For that reason, certain disclosed embodiments of the clamping unit should be adjustable to allow application of different preselected pressure levels to workpieces. Furthermore, embodiments described herein can either be used in a vertical or horizontal arrangement depending on the cavity design of the furnace or the opening of a conveyor furnace.

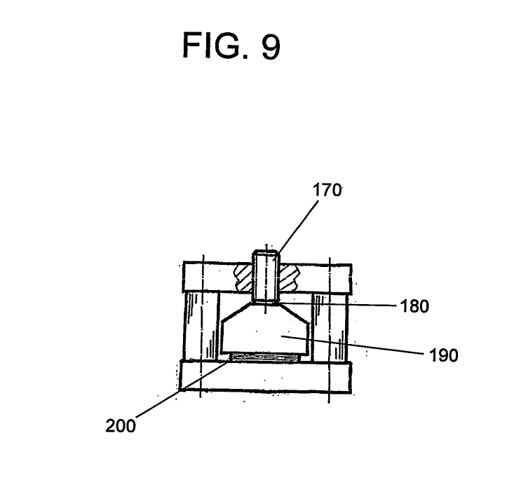

An embodiment of a bonding unit driven by thermal expansion is shown in FIG. 9. Referring to FIG. 9, integrated set screw 170 allows gap size adjustments to accommodate workpieces having different stack heights to guarantee certain modularity and the timing of bonding pressure by allowing an initial gap 180. Timing and magnitude of the resulting pressure are controlled by the gap adjustment. However, since the magnitude of the bonding pressure is based on stress-strain relations of the substrate material, the system shown in FIG. 9 is sensitive to changes either in temperature or initial gap adjustments.

a. Controlling Pressure Timing, Magnitude and Sensitivity

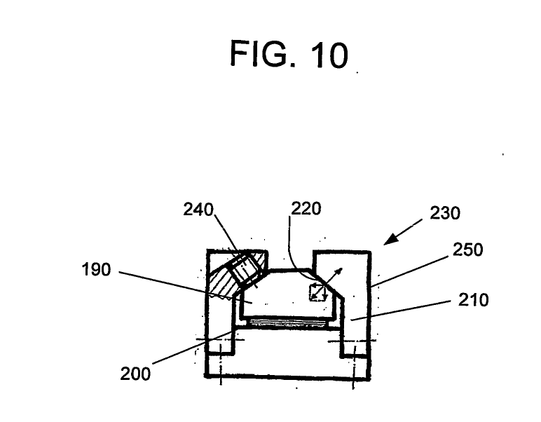

Overcoming the potential limitations of the embodiment shown in FIG. 9, one embodiment of a fixture of the present application is illustrated as fixture 230 in FIG. 10. Fixture 230 includes frame 250, engager 190 and platens embedded in the frame and engager. Frame 250 lessens pressure sensitivity by including an open structure having rigidity in the vertical direction. Frame arms 210 are flexible, and this flexibility allows a certain leveling of the overall pressure applied on a surface of substrate 200.

By introducing a contact angle 220 between frame 230 and engager 190, the bonding pressure can be decomposed into a vertical and horizontal force component. It currently is believed that this angle can be any angle greater than 0° and less than 90°, with the illustrated embodiment having a contact angle 220 of about 45°. The horizontal force component is transformed into bending of the frame arms 210 and does not apply bonding pressure to the substrate 200. The vertical force component is then the only component applying a resultant bonding pressure to the substrate 200. Because the vertical force component is less than the overall bonding pressure, the vertical force is lower, thereby resulting in a lower resultant bonding pressure to the substrate 200. As the overall bonding pressure fluctuates due pressure sensitivity, only a portion of the increased or decreased pressure is applied as resultant pressure to the substrate 200, the remaining portion being transformed into an increase or decrease in the bending of the arms 210. The end result is an overall reduction of pressure sensitivity in the microlamination of devices. The frame arms 210 could be designed to have a predetermined flexibility to control the pressure applied.

Set screw 240 for initial gap adjustment can be integrated on both sides of the frame arms 210. However, it would be preferable to make adjustments on the initial gap from one side and support the other side of the engager with a ball point tip (not shown). This configuration reduces the effects of a lack of parallelism and flatness that may compound within the stack. While this embodiment reduces pressure sensitivities associated with temperature fluctuation and gap height adjustment, and provides improved control over the timing of the application of bonding pressure, certain applications may require even greater control over the bonding pressure timing and magnitude.

In the diffusion bonding of microlaminated devices the final bonding pressure should not be applied before the bonding temperature is reached. This reduces warpage of the finned microchannel structures inside the laminae stack. The initial gap adjustment, as described above, facilitates adjustability in controlling the timing of the application of bonding pressure on the laminae. However, the theoretical study of the simple fixture design discussed above has shown that a desired bonding pressure due to differential thermal expansion is difficult to control because small changes either in temperature or initial gap size can result significant bonding pressure variations. Nevertheless, to yield a certain bonding quality it is preferable to minimize pressure sensitivity due to thermal fluctuations and gap size adjustments while controlling the timing of pressure due to thermal expansion.

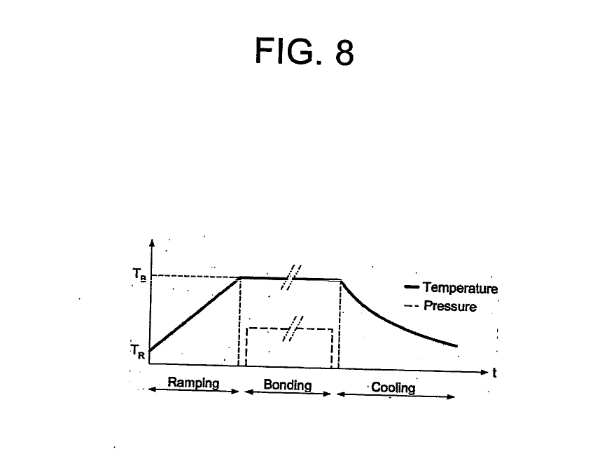

Controlling and timing pressure during a bonding cycle facilitates prevention of fin warpage inside the microlaminated device. In general, the bonding cycle is divided into ramping, bonding and cooling (FIG. 8). During the temperature ramp-up from room temperature (T_{R}) to bonding temperature (T_{B}), it is important that the patterned layers inside the clamp have the freedom to expand without restraint and that no pressure is applied to the stack. After the temperature has reached the bonding temperature, it is desirable to apply the bonding pressure. This initiates the bonding phase. Normally, a certain amount of lag-time between when the bonding temperature is first realized and application of a bonding pressure facilitates temperature uniformity before applying the bonding pressure. The bonding phase ends with the removal of bonding pressure and the start of the cooling phase. Before the temperature starts to drop, the bonding pressure has to be removed from the bonded device to, again, prevent thermal stresses during the cooling.

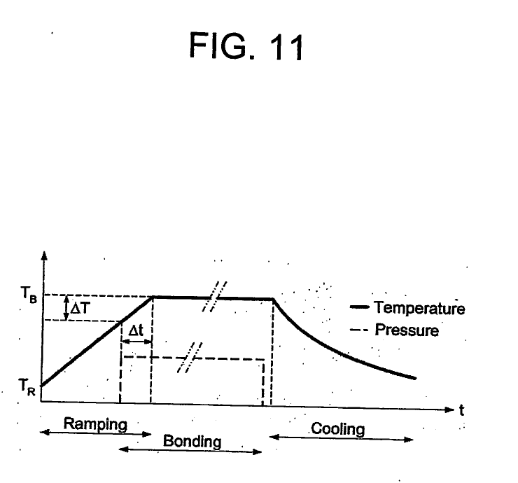

If the bonding pressure is applied a certain time (Δt) before the bonding temperature (T_{B}) is reached, as illustrated in FIG. 11, the residual temperature rise (ΔT) will cause the fins inside the laminae stack to warp. This warpage effect is caused by the pressurized sections of the stack being held in position due to frictional forces between the interfaces. Since the thermal expansion of typical graphite bonding fixture platens is significantly smaller than the expansion of the lamina material (generally by a factor of 4 to 5), the lateral expansion of the pressurized laminae stack is restricted by the expansion behavior of the graphite platens. The fin sections, which are not affected by the bonding pressure because they are not in direct contact with adjacent laminae, expand without restraint and, ultimately, the CTE difference between the layer material and the graphite will causes the fin sections to buckle.

In an ideal bonding cycle, bonding pressure will not be applied until ΔT=0, i.e., at the end of the heating ramp. As just discussed, delaying the application of pressure in this way prevents fin warpage since the thermal expansion of the fixture and laminae materials is complete. However, to apply a certain level of pressure at the desired bonding temperature with a differential thermal expansion fixture, contact must be made at some temperature, ΔT, before the final bonding temperature is reached (this temperature range also allows for any tolerances of the system). Within a vacuum hot press the timing, the magnitude and the leveling of the pressure can be achieved by dynamically controlling the hydraulic ram of the press. But static fixtures of the prior art using thermal expansion to produce bonding pressure cannot guarantee a predetermined level of pressure at the desired bonding temperature without producing some degree of undesired fin warpage. It is the development of a static fixture that is actuated by differential thermal expansion, yet accurately controls the bonding cycle key parameters that represents a major advantage of embodiments of the fixture disclosed herein.

Fin warpage effects can be minimized by accurately controlling the magnitude, timing and/or sensitivity of bonding pressure through the use of springs. The springs can be any design that provides a functioning device, but working embodiments generally included discs (Belleville). Since the springs have to deal with high loads at high temperature under minimal compression, high temperature, nickel-based disc (Bellville) springs are preferable. Disc springs generally are desirable because they maintain minimal compression even with high load forces. Furthermore, disc springs also are available in various materials and alloys, and can be capable of functioning at high temperatures. Despite the advantages of using disc springs, it is recognized that in certain applications, springs other than disc springs may be preferred.

By introducing springs in a non-preloaded state into the fixre design, the amount of thermal expansion will be consumed by the springs. The magnitude of the bonding pressure therefore is no longer dependent on the material properties of the fixture platens or the engager.

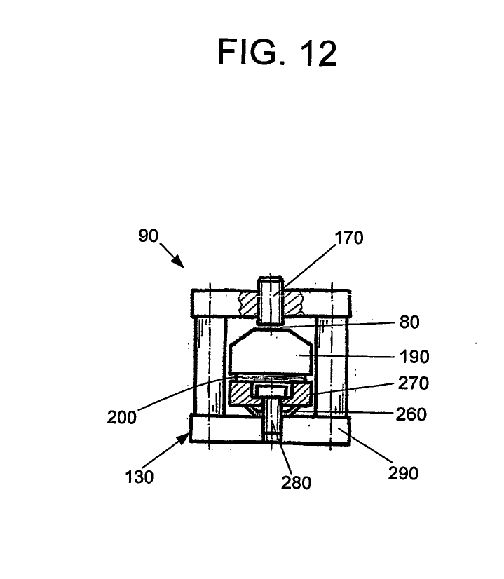

Another embodiment of a fixture 130 is shown in FIG. 12, spring 260 is preloaded to the desired final pressure level. Spring 250 in an unloaded state is held by fastener 280 and positioned between base plate 290 and load stage plate 270. The appropriate amount of preload force is then applied to the load stage plate with a weight or a hydraulic press and the fastener 280 is tightened to secure a predetermined amount of spring compression.

The initial compression of the preloaded spring (Δz_{c}) can be adjusted to determine a desired final pressure magnitude. With knowledge of the desired bonding pressure, the force load (F) can be evaluated by multiplying the bonding pressure (p) by the actual bonding area (A_{B}).
F=p·A_{B} (17)

The initial compression can be calculated roughly by dividing the compression force through the total spring constant (kₜₒₜₐₗ) of the preloaded spring where kₜₒₜₐₗ is obtained by multiplying the number of spring stacks (m) within the fixture times the number of springs (n) within each stack times the spring constant (k) of a single spring.

$$Δ {z}_{c} = \frac{F}{{k}_{total}} = \frac{F}{m \cdot n \cdot k} \qquad ( 18 )$$

If the CTE difference between fastener 280 and load stage plate 270 can be neglected and the bonding unit is used for low temperature bonding applications, then Equation 18 can be used. For the case where a significant difference in thermal expansion between fastener 280 and load stage plate 270 exists, the amount of differential thermal expansion has to be included in the net compression of the preloaded spring, especially by considering high temperature bonding cycles. Differences in thermal expansion can lead either to a higher compression or relaxation of the preloaded spring at contact temperature and the initial compression procedure has to compensate for differences accordingly.

$$Δ z = Δ {z}_{c} - Δ {z}_{corr} = \frac{F}{m \cdot n \cdot k} - ( {l}_{P} \cdot {α}_{P} - {l}_{F} \cdot {α}_{F} ) \cdot ( {T}_{C} - {T}_{R} ) \qquad ( 19 )$$

Equation 19 shows Equation 18 expanded by a correction term, which includes the difference in thermal expansion of the preloaded spring fastener and load stage plate. If the CTE of the fastener (α_{F}) is larger than the CTE of the load stage plate (α_{P}), the correction term will be negative and the difference is added to the net compression since, in this case, the preloaded spring would have been relaxed due to the temperature rise to the point of contact. Therefore, the amount of relaxation will be added to the preloaded spring compression at room temperature. In contrast, if the CTE of the load stage plate (α_{P}) is larger than the CTE of the fastener (α_{F}), the preloaded spring will be additionally compressed during the same temperature rise. Therefore, the correction term will subtract the amount of additional compression from the initial compression value at room temperature. Based on the above-developed relationships, the corrected force for the appropriate load cell compression at room temperature can be expressed as shown in Equation 20.
F=Δz·kₜₒₜₐₗ=p·A_{B}−(l_{P}·α_{P}−l_{F}·α_{F})·(T_{C-T}_{R})·m·n·k (20)

Taking the expansion behavior of the preloaded spring and associated components into account allows an adjustment to insure application of the final bonding pressure.

The final bonding pressure applied by fixture 90 is applied when engager 190 contacts frame 130 of the fixture 90, e.g., set screw 170, and the preloaded force is transmitted into the laminae stack 200, applying the desired final pressure magnitude. The timing of the force release can be controlled by the set screw 170 in the fixture frame 130 as already clarified in previous fixture embodiments. The initial gap 80 is selected so that contact is made a few degrees below the final bonding temperature to guarantee release of the pre-loaded force into the laminae.

Therefore, the application of bonding pressure can be accurately controlled to prevent fin warpage that may result from prematurely applying bonding pressure during the ramping-up stage. This is an important difference between disclosed embodiments of the present application and the prior art because prior art designs typically require changing the engager material or raising/lowering the engager volume to compensate for changes in processing conditions. This limits the range of applications that can be implemented by differential thermal expansion fixtures known prior to the disclosed embodiments of the present application. Using preloaded springs avoids altering the engager for different applications. This flexibility of the embodiments of the present invention utilizing preloaded springs is useful not only in diffusion bonding, but also in any thermal bonding process. Differential thermal expansion fixtures with preloaded springs will more accurately control the timing of the application of bonding pressure and the pressure's final magnitude.

In addition to timing and magnitude of the bonding pressure, it is useful to control the sensitivity of the bonding pressure as a function of temperature. Whether springs are preloaded as in the above embodiment or, as in another embodiment, the springs are not preloaded, but are initially coupled to the fixture in a non-compressed state, the use of springs decreases the pressure sensitivity of the bonding fixture. In this later embodiment, the resulting bonding pressure results from the amount of active spring compression related to the substrate area. With either embodiment, once the fixture has applied the final pressure for diffusion bonding, this level of pressure should stay constant within a certain tolerance range. Typically, pressure fluctuations associated with temperature fluctuations of ±5° C. in a standard furnace cavity have to be considered.

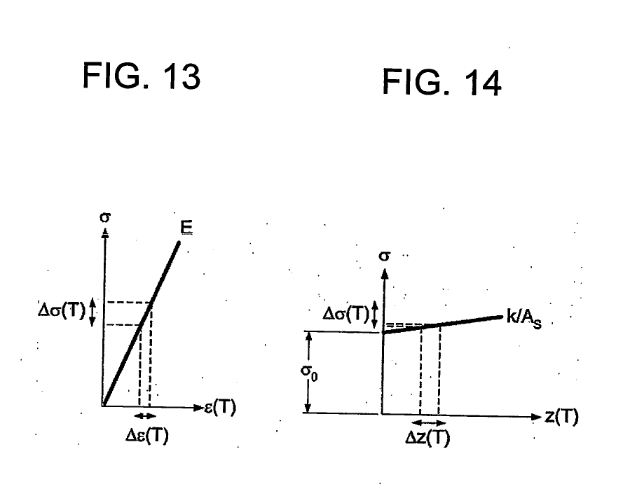

The analysis of the fixture embodiment illustrated in FIG. 6 has shown that the pressure sensitivity for a differential thermal expansion bonding unit with a solid engager is high and slight changes in temperature effect large swings in the bonding pressure. As has been discussed, a fixture not employing a spring, such as that shown in FIG. 6, may be unable to provide pressure uniformity from cycle-to-cycle and hence may not be applicable for mass production of microlaminated devices. For example, FIG. 13 illustrates stress versus strain as a function of temperature for the fixture embodiment shown in FIG. 6. And, by using Equation 21 below, where kₜₒₜₐₗ is the overall spring constant (mainly the sum of all springs used between the load platens), Δz(T) represents the amount of thermal expansion due to thermal fluctuations and AB is the bonding area, FIG. 14 similarly illustrates stress as a function of temperature for embodiments of fixtures of the present application that use preloaded springs. The change in stress, i.e., pressure sensitivity, for a given change in temperature with the fixture embodiment of FIG. 6 is greater than the pressure sensitivity of the fixtures having preloaded springs. Therefore, the several embodiments of the differential thermal expansion bonding unit of the present application that implement springs also minimize bonding pressure sensitivity.

$$Δ σ ( T ) = \frac{{k}_{total} \cdot Δ z ( T )}{{A}_{B}} = \frac{m \cdot n \cdot k \cdot Δ z ( T )}{{A}_{B}} \qquad ( 21 )$$

The modular design of the preloaded springs and associated components also permits the bonding pressure sensitivity to be adjusted simply by exchanging springs. For example, with low pressure applications, springs with lower spring constants can be used, while for some higher bonding pressure application, springs with higher spring constants can be used. For high temperature applications, the expansion of the inner components is higher and a spring with a lower spring constant can be used. Overall spring constants (kₜₒₜₐₗ) currently considered useful for embodiments of the fixture disclosed herein range from about 5,000 N/mm to 50,000 N/mm, more typically, from about 10,000 N/mm to 30,000 N/mm.

Each of the previous embodiments illustrates some unique features over the prior art and some trade-offs between fixture complexity, pressure magnification, timing and sensitivity. A reliable fixture design suited for high volume production as described herein has the ability to precisely control the major bonding parameters and not be affected by temperature changes of the furnace environment. The bonding fixture offers certain modularity for different stack heights and substrate sizes. Furthermore, because the summation of tolerances could lead to dimensional problems and incorrect pressure scaling, the overall complexity of the fixtures including the number of necessary parts is minimized.

In embodiments where the usable stroke of thermal expansion in the fixture is smaller, the fixture may be insufficient for certain high pressure applications, especially if small temperature changes are involved. As previously mentioned, the amount of thermal expansion is directly related to the height of the engager. Therefore, for applications where higher expansion rates are desired, using a long, highly-expanding tube would be advantageous.

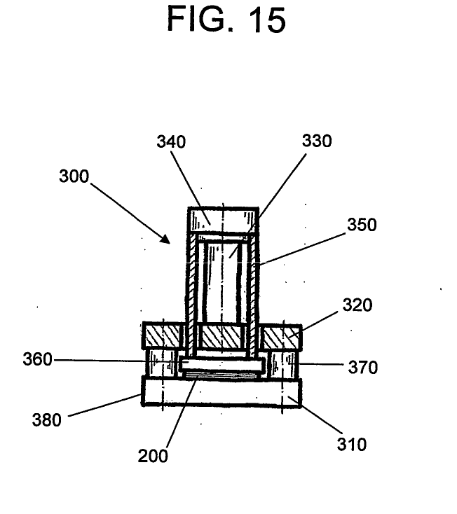

In one particular embodiment, as illustrated in FIG. 15, the engager of a laminae bonding fixture 300 is an expansion cylinder 350. Fixture frame 380 includes a base plate 310, frame posts 370, a cylinder mounting plate 320, a cylinder mounting rod 330 and a rod cap 340. Desirably, but not necessarily, the individual units of the fixture frame are made of ceramic. In the illustrated embodiment, the expansion cylinder 350 is a metal tube, such as a steel tube, constrained in its length between the cylinder mounting plate 320 and the base plate 310. Due to a higher thermal expansion coefficient compared to ceramic, the metal tube expands relative to the frame and applies pressure to the pressure distribution plate 360 at elevated temperatures, which in turn distributes the pressure to the substrate 200. The expansion cylinder position is designed to effectively absorb heat in a conveyor belt furnace, such as the one shown in FIG. 4.

An expansion cylinder provides some significant advantages compared to a solid engager. The relevant amount of thermal expansion created in the vertical direction for a cylinder with length L is the same as for a solid engager with height H=L; nevertheless, the related volume and thermal mass of an engager is significantly higher and hence must absorb more heat than the cylinder to achieve the same expansion. Furthermore, the free space inside the cylinder can be utilized in the fixture design. As shown in FIG. 15, the cylinder mounting rod 330 extends out of the cylinder mounting plate 30 and up through the cylinder 350. This extended expansion tube design provides a significant amount of thermal expansion along the axis of the cylinder 350.

While the particular embodiment illustrated in FIG. 15 provides an increase in the thermal stroke of the expansion unit and minimizes volume, the pressure sensitivity associated with this embodiment may be high for certain applications. This pressure sensitivity can be minimized, however, by integrating a spring as described herein. By adding springs with different spring constants, the force applied to the substrate can be controlled. For example, without a spring, thermal expansion of the expansion tube works directly against the substrate and results in a very high bonding pressure at high bonding temperatures. By using a spring, the bonding pressure can be adjusted to lower levels. Thermal elongation of the tube works against the spring and finally creates the bonding pressure. Furthermore, adding springs has a positive effect on the pressure distribution uniformity by equalizing the pressure among the springs.

Although not shown, the embodiment illustrated in FIG. 15 can include a preloaded spring as described above. A preloaded spring can be positioned between cylinder mounting rod 330 and rod cap 340. Including a preloaded spring provides control of the magnitude and timing of the pressure applied by the expansion cylinders 350 to the substrate 200.

Each of the previous embodiments illustrates some unique features over the prior art and some trade-offs between fixture complexity, pressure magnification, timing and sensitivity. A reliable fixture design suited for high volume production as described herein has the ability to precisely control the major bonding parameters and respond insensitive to temperature changes of the furnace environment.

The following example is provided to illustrate certain features of a working embodiment. The scope of the disclosed embodiments should not be limited to the particular features exemplified.

### EXAMPLE 1

Different experimental designs were applied to prove the functionality of differential thermal expansion fixtures for high volume production of microlamination devices. Fuji pressure sensitive measurement film was used to evaluate pressure uniformity, magnitude and timing in the low temperature regime. Special test articles were designed to study the timing of pressure at higher temperature during microlamination. The behavior of fin warpage was used as a reference for the calibration of the bonding fixture (pressure timing). The test articles were also used for the metallurgical assessment of the bond line. The void fractions of bonded samples were compared with samples bonded within the hot press under similar conditions. Finally, an analysis was performed to compare samples bonded in the differential thermal expansion fixture and samples bonded within the hot press to determine if the differential thermal expansion fixture is capable and repeatable.

1. Setup

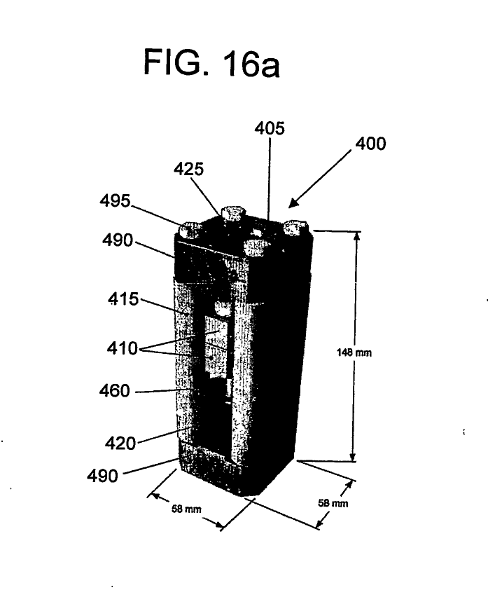

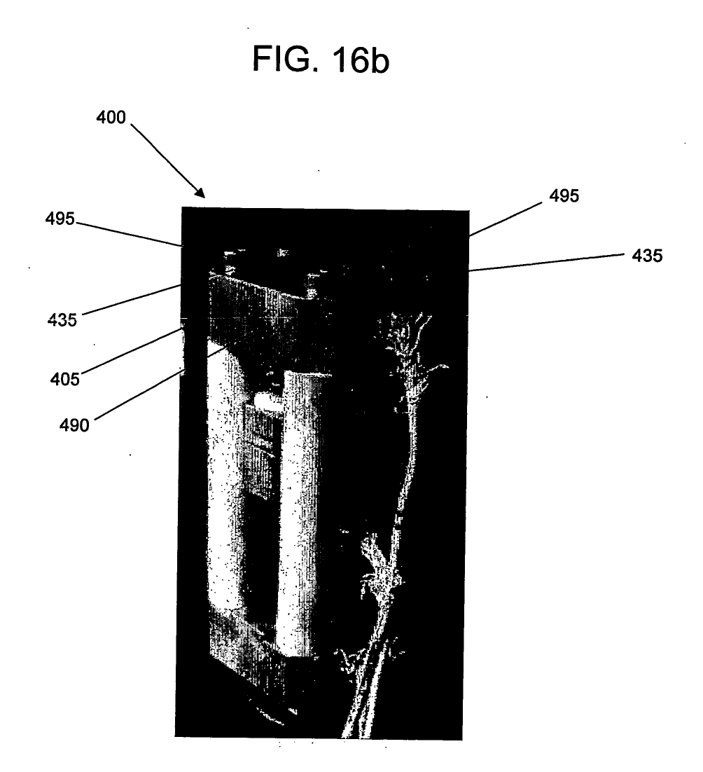

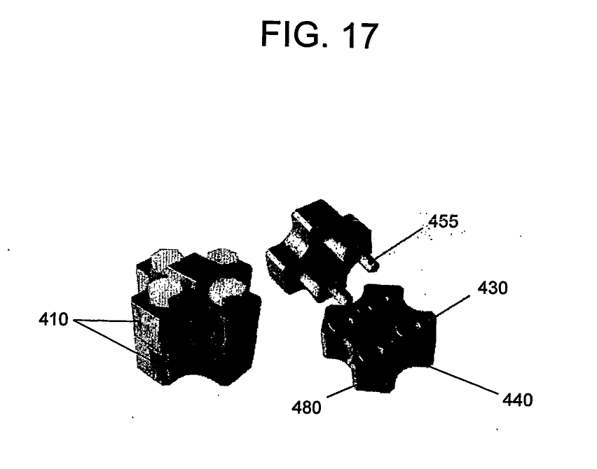

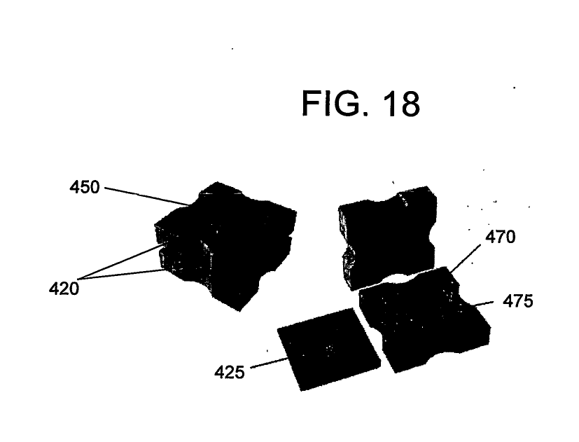

FIG. 16a shows one working embodiment of differential thermal expansion bonding fixture 400 designed for the Pressmaster hot press. The working embodiment is based on the differential thermal expansion fixture embodied in FIG. 12 and the hot press is used to simulate conditions in a high volume production, open-ended furnace. Fixture 400 includes a frame 405 having plates 490, posts 415, gap height adjustment screw 425 and fasteners 495. In one embodiment, shown in FIG. 16b, frame 405 includes compliant springs 435 positioned between plate 490 and fasteners 495. The springs 435 facilitating frame compliance, i.e., reducing pressure sensitivity by softening the frame. The load cell 410 and bonding platens 420 can be seen in more detail in FIGS. 17 and 18, respectively. Best shown in FIG. 17, disc springs 430 were placed between load cell plates 480 and were kept in position within spring pockets 440 and load cell fasteners 455. Besides positioning, the spring pockets 440 were used to prevent the disc springs from flat loading. Similarly, as shown in FIG. 18, the top plate of bonding platens 420 has a centering pocket 450 to secure the exact position of engager 460 relative to the laminae 470. Alignment pins 475 facilitate registration of the laminae 470 and pressure distribution plate 425 facilitates equal pressure distribution to the laminae 470.

All lamina of the test article were made from copper shim stock alloy 110 with a thickness of 8 mil (203 μm). Before bonding, all lamina of the test article were cleaned in an ultrasonic cleaner with acetone, methanol and de-ionized water (AMD rinse) to remove grease or any residues on the lamina surfaces. The bonding fixture assembly was then put in the vacuum chamber and the chamber was pumped down to an approximate level of 10⁻⁴ torr before the bonding cycle was started. For all bonding cycles, a temperature ramp of 20° C./min was applied. The point of pressure application, the magnitude of bonding pressure and the bonding duration were dependent on the individual experiments.

A first investigation into the relationship between the point of pressure application during a bonding cycle and resulting fin warpage was set up. An investigation of this type would make it possible to adjust the appropriate timing of the differential thermal expansion fixture, since the amount of fin warpage is related to the temperature difference between contact and bonding temperature. Taking the thermal expansion potential of the fixture into account, the exact gap correction was calculated to offset the contact point for an optimal pressure timing.

The experimental design for the pressure timing investigation was based on a multifactor categorical design with two experimental factors, bonding temperature and contact temperature. Bonding temperature within the vacuum hot press was set to 600° C. for a first run and to 800° C. for a second run. The temperature of pressure application, or contact temperature, was based on the bonding temperature and varied on three settings between 0%, 50% and 100% of the bonding temperature. Six randomized experimental runs with two samples per run were performed for a total of twelve test articles. The bonding cycle was carried out with the vacuum hot press at 10⁻⁴ torr with an applied bonding pressure of 8 MPa for 30 minutes. A temperature ramp of 20° C./min was used for all experimental runs. The resultant fin warpage was measured with a Dektak³ profiler at three different positions (left, middle, right) for each fin.

Knowledge of the relationship between force and displacement, mainly given by the spring constant of the springs 440 used in the experiments, is important for the correct setting of bonding pressure. In one particular embodiment, springs 440 are Inconel Belleville disc springs with an outside diameter of 0.625 inches, an inside diameter of 0.317 inches and a thickness of 0.032 inches. The springs had a theoretical nominal load capacity of 180 lbs (800 N) by a deflection of 0.0115 inch (292 μm), which relates to a theoretical spring constant of 2740 N/mm. The total spring constant for the load cell was four times the value of a single spring, i.e., 10,960 N/mm.

The theoretical spring constant was validated by measuring the deflection of the load cell due to force application. The load cell 410 was put between the hydraulic pushing rods of the Pressmaster hot press and the applied force was measured using an OMEGA high performance strain gauge indicator. The deflection of the load cell was measured with a precise Mitutoyo dial gauge with an incremental resolution of 0.0005 inch (12.7 μm). Loads and deflections were recorded with the slope of the linear regression equaling the spring constant of the load cell. The linear fit showed good agreement with the theoretical spring constant and delivered a total spring constant for the load cell of 11,215 N/mm, i.e., only a 2.3% difference compared to the theoretical spring constant. This value corresponds to an actual spring constant of 2804 N/mm for each individual disc spring.

As discussed above, a uniformly distributed pressure correlates bond quality across the entire substrate area However, the pressure distribution is rather difficult to be quantified, especially in a closed furnace at elevated temperatures. The use of Fuji Prescale film has been found as a common measurement tool for the analysis of pressure uniformity in similar applications like embossing or general lamination procedures. Fuji Prescale film is a measurement film that can measure pressure and display its distribution according to different color densities for different pressure levels. For pressure levels below 50 MPa the film is a two-sheet, polyester-based film. One sheet is coated with a layer of microencapsulated color forming material (A-film) and the other sheet with a layer of color developing material (C-film). When pressure is applied, the microcapsules break and the color forming material reacts with the color developing material and red patches appear on the film. The film thickness is 0.2 mm and has a pressure reading accuracy of ±10%. Unfortunately, the recommended temperature for the film does not exceed 35° C. Fuji Prescale films can be used at elevated temperatures by sandwiching the film between Kapton™ film. With this method, the film remained functional up to temperatures of 190° C.

The two-type film was used for low temperature experiments to investigate and optimize the pressure uniformity and the timing of the working embodiment fixture. Type LW Fuji Prescale film with a detectable pressure range of 2.5 to 10 MPa was used. The film was preliminary processed at different pressure levels in the hot press to produce reference samples. The bonding pressure was varied from 3 MPa to 6 MPa in steps of 0.5 MPa The film was processed between the bonding platens of the differential thermal expansion fixture shown in FIG. 18 to guarantee equivalent conditions and to validate the pressure distribution.

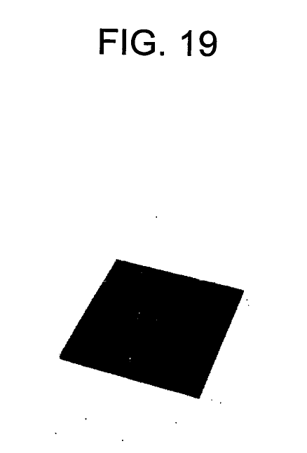

By using Fuji Prescale film to determine the pressure transmitted in the fixture, conclusions can also be drawn regarding the timing of the bonding pressure. The initial gap size was varied from zero up to a point where no contact between the fixture frame and load cell was established. The pre-load settings for the load cell were maintained constant at a resultant pressure of 4 MPa Because of the limitations of Fuji film at higher temperatures, a test article made out of copper according to FIG. 19 was developed for the pressure timing validation at higher temperatures. The test article shows a toothed structure, where each tooth is systematically bent-up after laser cutting. When placed between platens and after pressure is applied, the toothed features are pressed down onto a base layer of the structure and eventually bonded together, thus indicating transmitted pressure. A more precise validation can be made after the pressure cycle by examining the teeth with the surface profiler. Thus, these laminae stacks can be used to investigate the timing of bonding pressure at high temperatures based on initial gap adjustments.

A second investigation was set up to evaluate the functionality of the new proposed bonding method for the application in a microlamination procedure. A multifactor categorical design (2⁴) was chosen to evaluate whether bonded laminae stacks, produced by a differential thermal expansion fixture were statistically different from those produced with a hot press. Mode, temperature, pressure and time were selected as the independent variables. The factor mode varied at two levels between “fixture” and “hot press”. Temperature was varied between 500 and 800° C. and time between 30 and 60 minutes respectively. Pressure was set to two levels, 3 MPa and 6 MPa. For hot press samples, the point of pressure application was at the end of the bonding ramp to prevent fin warpage. For the differential thermal expansion fixture, the point of pressure application was adjusted within 50° C. before the final bonding temperature was reached. The experimental design was fully randomized with one replication for a total of 32 experimental runs. Since each run can process two samples, a total of 64 test articles according were processed for measurements. Fin warpage and void fraction of the bond line were selected as the dependent variables of the experiment. Measurement of fin warpage followed the procedure as outlined above for the first investigation. After the measurement of fin warpage, test articles processed at same conditions were molded in epoxy for metallographic examination of the bond lines.

As discussed in previous sections, the cool down time of the vacuum furnace results in a major loss of time in the production cycle of a microlaminated device. Therefore, a third investigation was conducted into the influence of helium as a cooling gas to cut down the cycle time during microlamination. The low density of helium gas results in an unusually high specific heat compared with other noble gases, therefore, it is a favorable gas for cooling. Only hydrogen would provide faster cooling rates, but with additional safety issues to overcome when compared to helium gas.

Quenching was accomplished by isolating the vacuum chamber of the Pressmaster hot press from the vacuum pump system (by closing the gate valve) and slowly introducing helium into the chamber at an over-pressure of 10 psi. The helium line continued to feed during the cool down to compensate for any leakage of the chamber.

2. Results

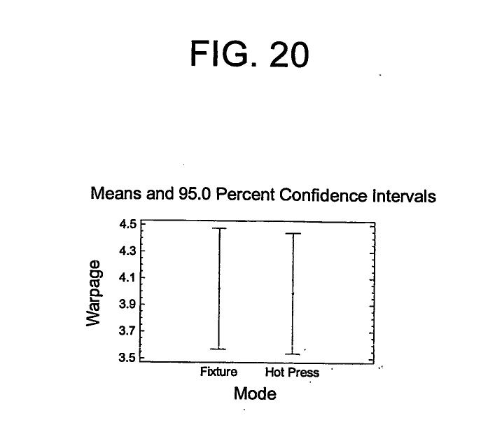

After processing the 32 experimental runs the fin warpage was measured on the 64 test articles by scanning the channel fin with the Dektak³ surface profiler. Since each test article had two fins a total of 128 measurements were taken. A multifactor analysis of variance (ANOVA) was performed to decompose the variability of the measured fin warpage into contributions due to the various factors and their interactions. FIG. 20 visualizes the mean warpage in μm for a test article using hot press techniques compared to a test article using thermal expansion techniques with a 95% confidence interval.

The grand mean of the total 128 measurements processed at various bonding conditions is 4.01 μm of fin warpage. This average fin warpage relates to a deviation in channel height of 2% and would not negatively affect the performance of a heat exchanger. The mean fin warpage for specimens processed within the ΔCTE-fixture was calculated as 4.02 μm where the mean for specimens processed in the hot press was found to be 3.99 μm as shown in FIG. 20. Based on the results of this experiment, it can be concluded that warpage resulting from the diffusion bonding of devices within a ΔCTE-fixture is not any different from the warpage resulting in processing devices in a hot press system.

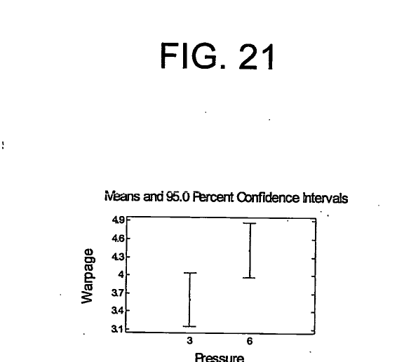

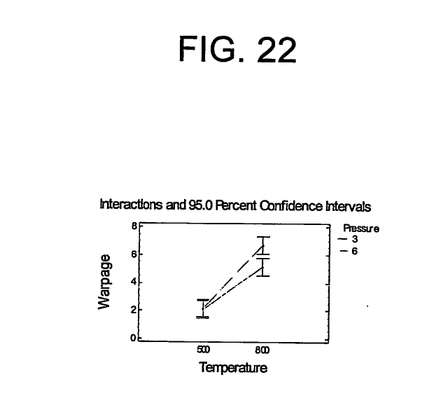

From the investigation, temperature clearly has a statistically significant effect on fin warpage since the fin buckling behavior is directly related to the coefficient of thermal expansion (FIG. 20). Also pressure was found to significantly affect fin warpage (FIG. 21). Similarly, the interaction of temperature and pressure has a statistically significant effect on fin warpage as shown in FIG. 22. No statistically significant effect on fin warpage was found for the experimental factor bonding time.

From FIG. 22, it can be seen that at lower temperatures the fin warpage is independent of the level of applied bonding pressure. However, at higher temperatures the application of a higher bonding pressure yields a significantly higher fin warpage than seen for a lower pressure. This is because a misregistration in the layer stack creates a bending moment at the fin boundaries, which is directly related to the level of pressure applied on the stack. Since the stiffness of the fin decreases with increased temperature the fin warpage will be more sensitive to the level of bonding pressure at higher temperatures.

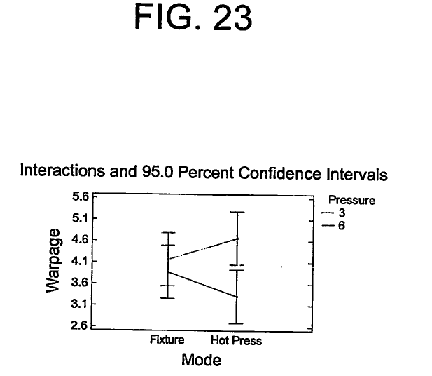

An interesting relation can be seen by looking at the interaction plot of the experimental factors mode and pressure as illustrated in FIG. 23. The fin warpage observed within the ΔCTE-fixture is less dependent on the level of pressure than seen for the hot press. The fin warpage for different levels of pressure is significantly different by using the hot press whereas the ΔCTE-fixture does not show a significant difference of fin warpage for different levels of pressure. This could be due to the more dynamic impact of pressure application within the hydraulic hot press. Therefore, the dynamic nature of a typical bonding process in a hot press may be causing greater warpage than with a differential thermal expansion bonding fixture. Consequently, the static nature of thermal expansion bonding fixtures alone may result in decreased fin warpage effects.

After measuring the fin warpage, samples bonded at similar conditions were molded in epoxy for metallurgical inspection of the bond lines. Eight different bonding conditions based on pressure, temperature and time resulted in 16 total samples across the two bonding platforms. Each sample contained four test articles and was cut through the center of the test articles with a diamond wafer blade. Subsequent polishing of the samples allowed the metallurgical inspection of the bond lines and determination of the void fractions at the different bonding conditions. Ten video images of the bond lines were taken for each sample for a total of 160 metallurgical pictures. An observation length of 250 μm for the determination of the void fractions was defined with the video measurement system (VIA-100) on a LEICA optical microscope. Voids at the bond lines were marked on a transparency foil on the computer screen at a magnification of 384×. The void fraction (v_{f}) at the bond lines were calculated according to Equation 31.

$${v}_{f} = \frac{\sum {l}_{void}}{{l}_{0}} \cdot 100 \% \qquad ( 22 )$$

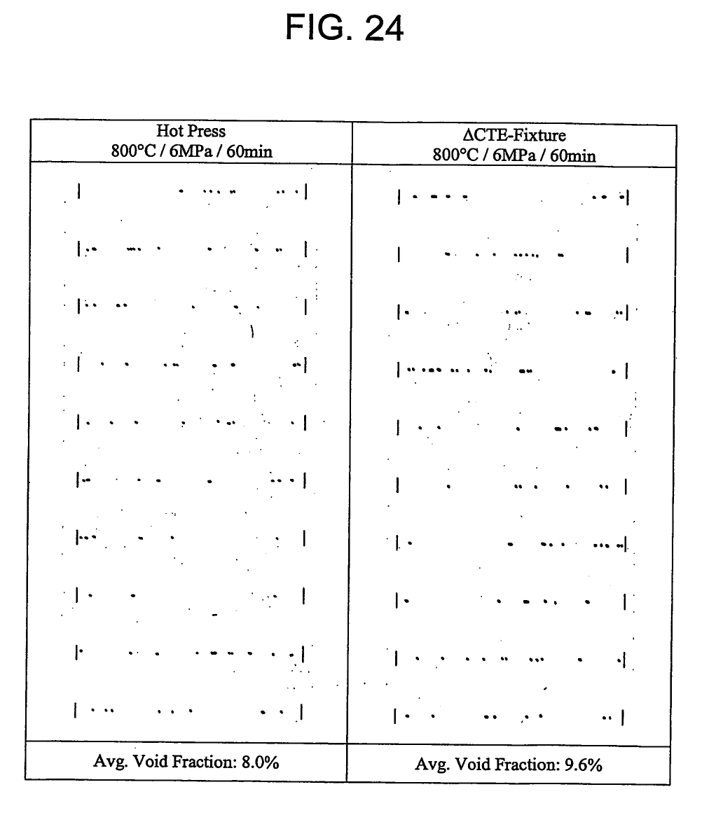

The working embodiment of the differential thermal expansion bonding fixture yielded predictable bonding results. These results were similar to typical hot press bonding results, especially at high temperatures, as shown in the void fraction comparison in FIG. 24.

The foregoing demonstrates that high volume differential thermal expansion fixture embodiments of the present application functions as desired. Direct comparisons with thermal batch processing in a vacuum hot press even at high temperatures of 800° C. without significant fin warpage effects and with high bond quality as visualized in FIG. 23. Therefore, it can be concluded that this bonding approach is plausible for the microlamination of MECS devices.

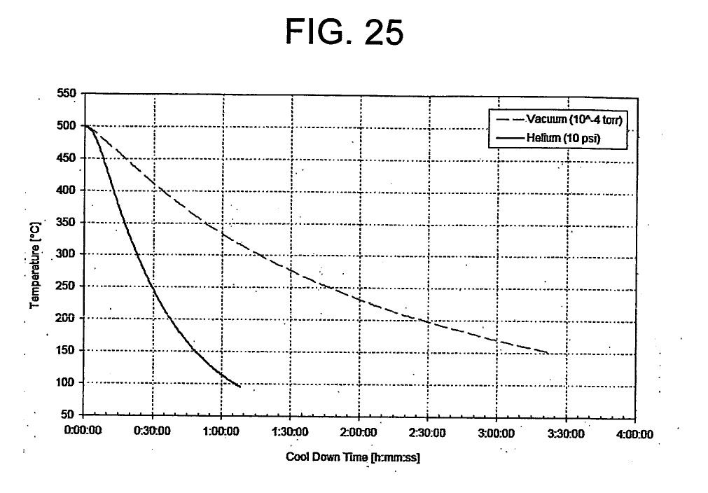

Furthermore, evaluating the results of the third investigation led to a conclusion that using a gas to assist in the cooling down cycle has significant benefits over not using a gas. A comparison of the cool down from 500° C. in vacuum (10⁻⁴ torr) without the introduction of a gas compared to a vacuum with the introduction of helium is illustrated in FIG. 25. The use of helium as a cooling assist during the cool down cycle in the diffusion bonding process can cut down the cycle time by more than 75% (increases the cooling rate by more than 4 times). The cool down time in a vacuum (for this example 10⁻⁴ torr) starting from 500° C. down to 100° C. takes over four hours. Using 99.5% helium, cool down from 500° C. to 100° C. was achieved within one hour.

b. Large Substrate Applications

With microlamination devices generally, one difficulty is to find a design which equally distributes pressure on the substrate area for a consistent bonding quality. This is rather difficult when dealing with large substrates, for example, substrate sizes of 1 meter by about 1 meter or an area of about 1 m², sometimes about 24 inches by 24 inches or an area of about 576 in², or more typically about 8.0 inches by 8.0 inches and non-square substrates having an area up to at least 64 in². It would be advantageous to be able to use a differential thermal expansion bonding unit for high volume microlamination of large substrate devices. Using techniques known in the art, diffusion bonding of large substrates is only feasible with the use of large hot press systems or by hot isostatic pressing (HIP). However, the uniaxial pressure application of a hot press system is problematic for achieving bonding pressure uniformity over a large substrate in a high volume production process. This is because both methods are very cost intensive and are not applicable for mass production. Thus, a differential thermal expansion bonding unit that enables a more economical approach for mass producing large-substrate microlaminated MECS devices within a continuous furnace is desired.

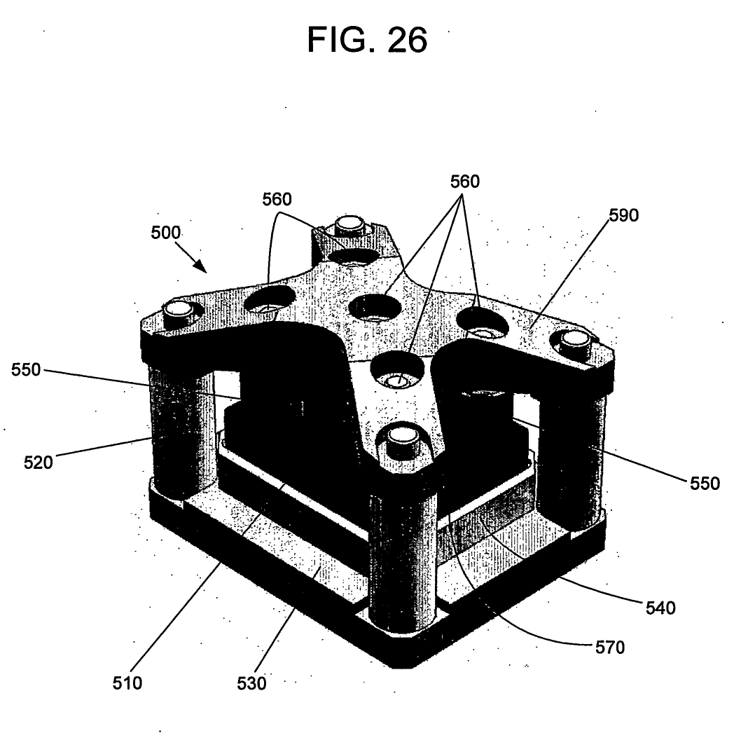

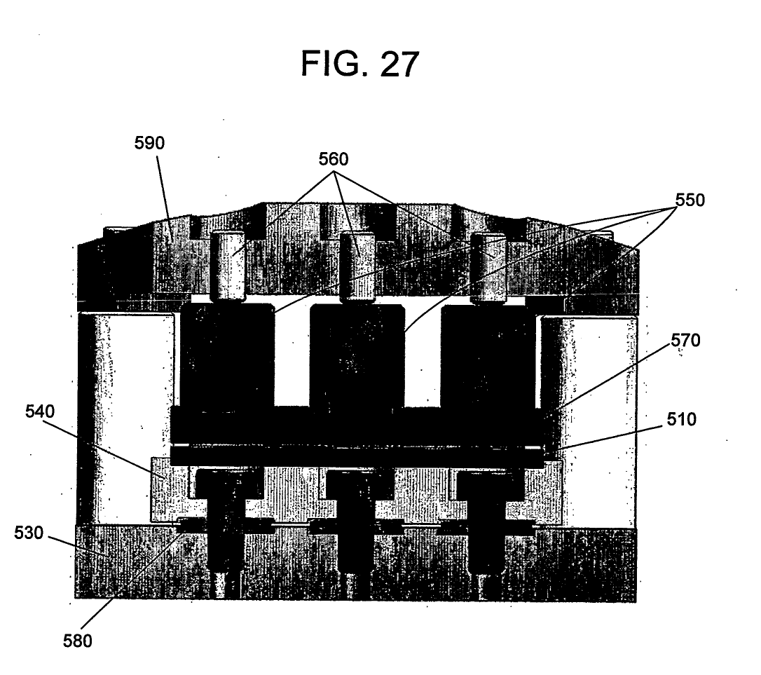

FIGS. 26 and 27 show an embodiment of a large substrate fixture 500 with a bonding area of around 3 inches by 4 inches. Fixture 500 generally includes the same principal features as in the previous embodiment shown in FIG. 12 for a small substrate fixture. However, fixture 500 utilizes additional features for establishing pressure uniformity over larger substrates. Furthermore, as with the frame construction for small substrate fixtures, large substrate fixtures typically are stiff and rigid to minimize the impact of frame deformation. Since the distance between fixture posts 520 and engagers 550 is increased with embodiments employing a large substrate design, the fixture 500 will experience higher bending moments and therefore, more deformation. Thus, fixtures for large substrates must be designed to resist potentially greater deformation and provide uniform pressure distribution. It also is desirable in mass-volume applications to keep the weight and the thermal mass of the fixture small, and therefore, a lean frame also is desirable.

Fixture 500, shown in FIGS. 26 and 27, is useful for mass production of microlaminated large substrates by uniformly distributing pressure, maximizing stiffness and minimizing weight. Fixture 500 includes springs 580 (FIG. 27) located between frame base 530 and load stage 540. Graphite bonding platens 510 are centered in the load stage 540. Load stage 540 is designed to receive platens of various sizes, which depend on the size of workpiece 570 and the alignment features between the platens. Engagers 550 are positioned on top of the bonding platens 510. As shown in FIG. 27, according to one embodiment, engagers 550 may be expansion cylinders as discussed above. Generally, multiple engagers or expansion cylinders are distributed over the area of workpiece 570. For square or rectangular workpieces, four engagers contact the corners and one contacts the center of the workpiece. Individual initial gap sizes can be adjusted for each engager by adjusting set screws 560. Adjusting individual initial gap sizes in this manner facilitates the leveling out of pressure differences across the substrate area Frame deformation can be minimized by adjusting a set screw positioned in the center of the fixture to create a smaller initial gap in the center than in the corner sections since the deformation will be maximal in the top frame center. Hence, using set screws 460 to adjust initial gap sizes results in a leveling out of pressure differences across the substrate area and reduces deformation.

To reduce weight and thermal mass, fixture 500 includes a streamlined top plate 590. Top plate 590 is designed to minimize material, hence minimizing weight and volume, while maintaining adequate stiffness for high volume microlamination production of large substrates.

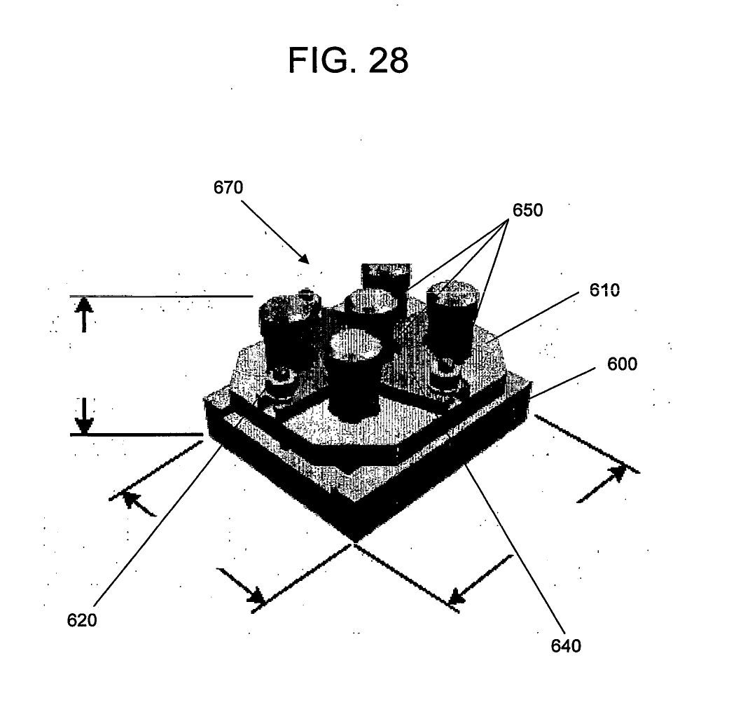

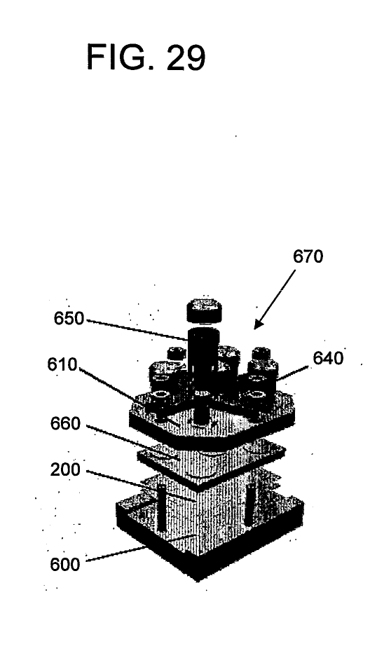

Further recognizing the need for increased stiffness and decreased weight and thermal mass for fixtures used in the high volume production of microlaminated devices, FIG. 28 shows another embodiment of the present application. FIG. 18 is an exploded view of this embodiment. As best shown in FIG. 29, fixture 670 utilizes the expansion cylinder concept associated with FIG. 15 but modified for use with high volume production of large substrates.

According to this embodiment, base plate 600 receives and is secured to cylinder mounting plate 610 with fasteners 620. Mounting plate 610 is slightly tightened onto the substrate 630. Fix plate 640 holds mounting plate 610 in position and equally distributes the pressure to substrate 200 (FIG. 29).

The main components of the unit shown in FIGS. 28 and 29 are the plural (five in the illustrated embodiment) expansion cylinders 650 as discussed above. As expansion cylinders 650 expand, they come in contact with and apply pressure to a pressure distribution plate 660, which applies pressure to substrate 200 (FIG. 29). Metallic parts, like the fix plate 640 and the expansion tubes 650, preferably are made out of high temperature alloys, such as INCONEL™.

Slight differences in the length of expansion cylinders 650 could possibly lead to non-uniform pressure distribution. However, designed differences in the length of the tubes may be used to control the pressure distribution over the substrate area. Also the location of the expansion tubes relative to the substrate should be considered to provide a uniform distribution.

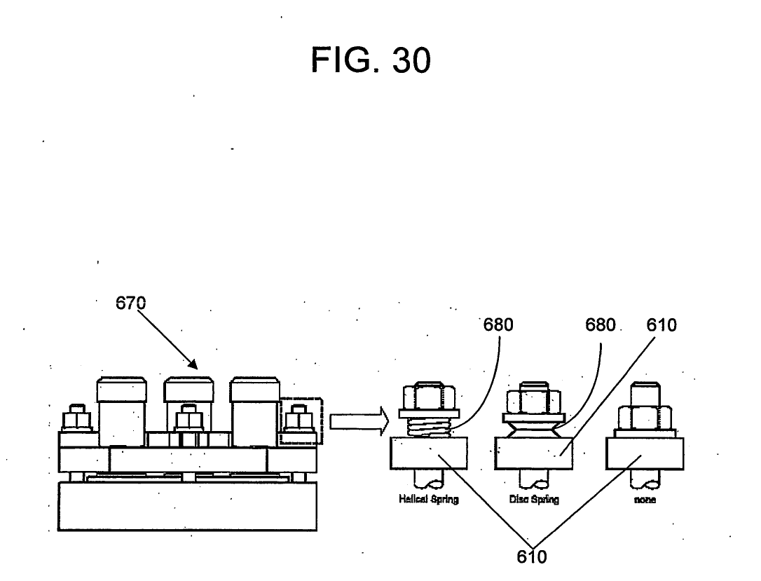

Additionally, as discussed above with regard to the fixture embodiment shown in FIG. 16b and further shown in a fixture embodiment with expansion cylinders shown in FIG. 30, springs 680 may be integrated into a fixture frame to facilitate fixture compliance. Although FIG. 30 shows springs on a fixture embodiment using expansion cylinders, it is recognized that springs can be integrated into fixture frames of all embodiments of the present application. According to one fixture embodiment for large substrates, springs 680 are helical springs. According to another embodiment, springs 680 are disc springs, such as Belleville disc springs.

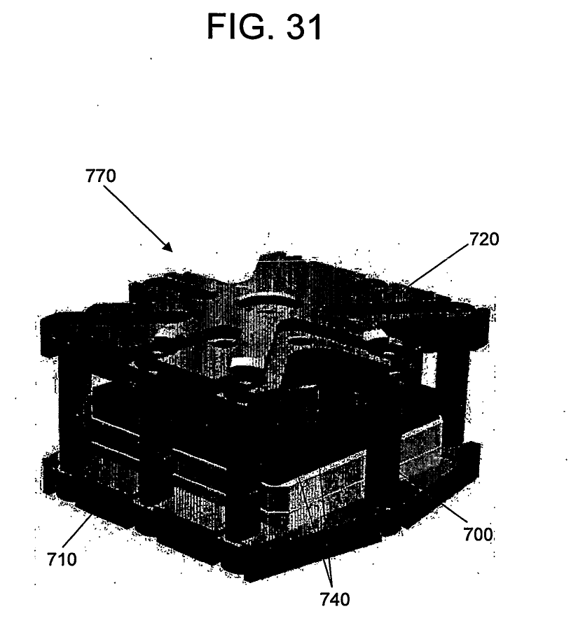

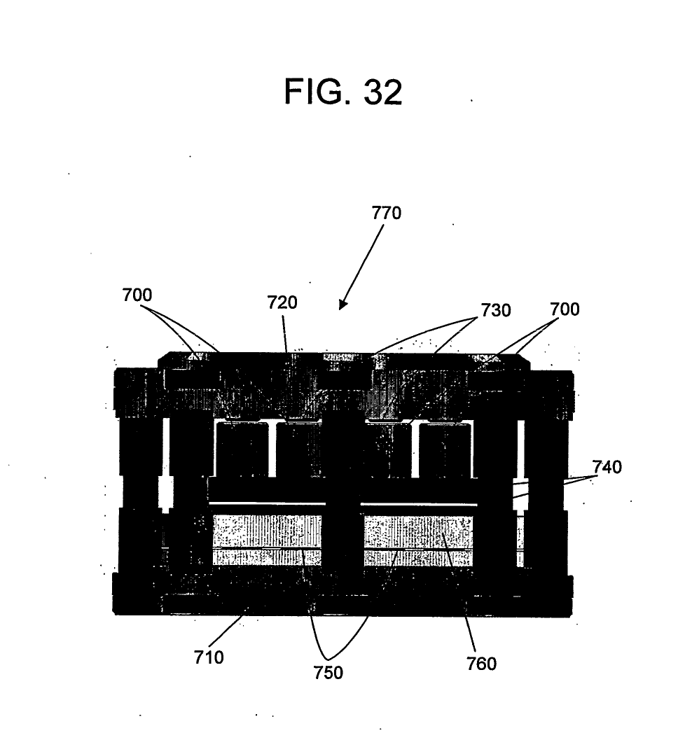

FIGS. 31 and 32 show an embodiment of a large substrate fixture with a bonding area of 8 inches by 8 inches. Similar to FIGS. 15 and 16, the fixture 770 shown in FIGS. 31 and 32 includes engagers 700, base plate 710, top plate 720, set screws 730, platens 740 and springs 750. However, to compensate for larger substrate sizes, this embodiment includes at least seven engagers 700. Like FIGS. 26 and 27, each engager has a corresponding initial gap adjusting set screw 730. By individually adjusting the set screws 730, pressure uniformity and minimization of deformation is established.

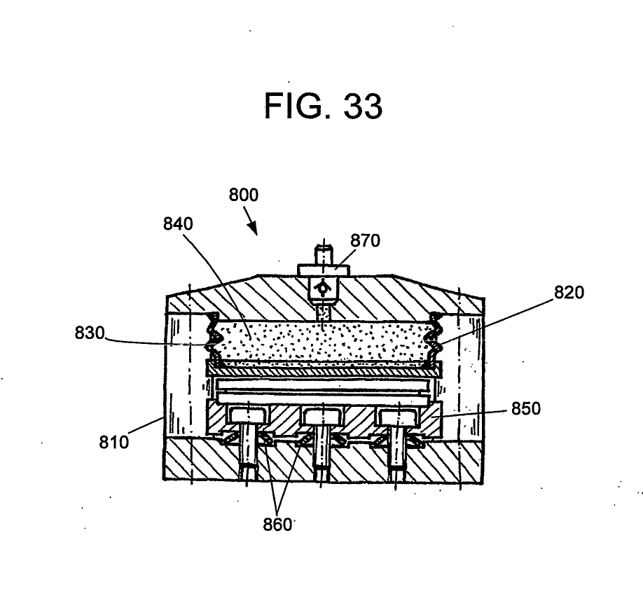

The weight and size of certain large substrate bonding fixtures applicable for mass production may be constrained by the specifications of some types of continuous furnace systems (e.g. furnace openings and total load capacity of the conveyor belt). The large substrate concept shown in FIGS. 26, 27, 31 and 32 could exceed some furnace system specifications due to the weight and structural height of the solid engagers. A potential solution to overcome the issues of fixture size and weight is presented in FIG. 33, wherein the solid engagers of FIGS. 26, 27, 31 and 32 are replaced with a gas/liquid expander.

In FIG. 33, the fixture 800 includes a gas/liquid expander 820. Gas/liquid expander 820 includes a bellows 830 filled with a fluid 840, which may be a liquid or a gas, with a much higher thermal expansion compared to the fixture frame 810. The pressure magnitude and sensitivity is controlled by using a preloadable load stage 850 with springs, particularly high-temperature springs 860. Pressure engagement (pressure timing) is controlled by the volumetric expansion of the bellows 830 due to the temperature rise from room to bonding temperature. Initial gap settings can be controlled by setting a primary level of pressure inside the bellows 810 using an inlet valve 870. Additionally, if a preset pressure threshold is reached, any excess pressure is relieved through a pressure relief valve (not shown). In this way, the pressure sensitivity of fixture 800 can be further reduced by setting an upper pressure limit. Furthermore, the use of a gas/liquid expander provides a more uniform pressure engagement over large substrate areas up to at least 576 in² and promotes a fixture design that is more durable, smaller (e.g. smaller profile) and lighter (e.g. lower thermal mass and/or weight), which is important, amongst other reasons, for the selection of the conveyor. Reducing the mass also reduces the thermal mass of the system, and hence the heating requirements. This will become increasingly more important as economics dictate the use of ever larger substrates for the microlamination of MECS devices.

While FIG. 33 shows the application of a gas/liquid expander to the large substrate bonding fixtures of FIGS. 26, 27, 31 and 32, it is recognized that the gas/liquid expander concept can also be applied to other small or large substrate bonding fixtures.

E. Registration with Integral Compliant Features

As mentioned previously, laminae alignment is a feature in the successful production of microlaminated MECS devices. Pin and TEER alignment systems have been described. TEER alignment initially resulted in relatively poor alignment and buckling of the substrate. Thermally unconstrained aligning showed good bonding results, but substrate alignment was uncertain. Mixing both approaches allows thermally-assisted registration with a controlled alignment of the substrates during the whole bonding cycle at every temperature level. Moreover, it is possible to register workpieces having a cylindrical geometry with a high degree of precision using compliant features that are integral with the laminae.

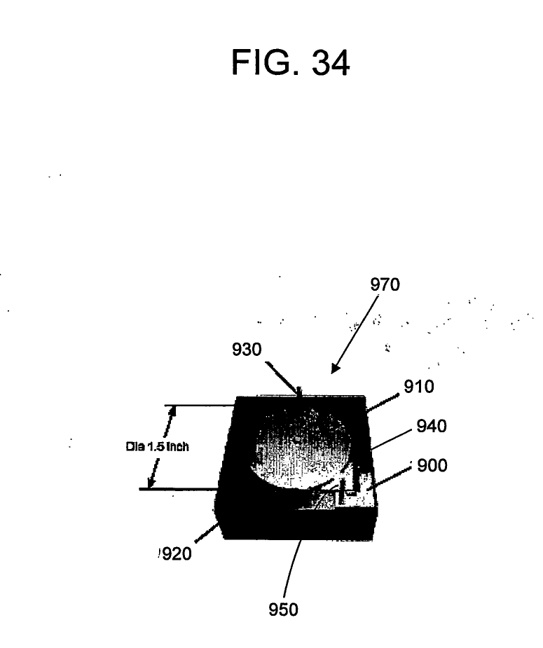

The fixture embodiment 970 shown in FIG. 34 can align lamina having shapes in addition to substantially square or rectangular. For example, cylindrical discs, such as cylindrical stainless steel discs, with a highly precise etched pattern on an inside surface, have been registered and bonded to each other so that a single microchannel results after bonding. The smallest channel features on the circumference of this working embodiment were about 100 microns and a maximal misalignment of five microns at a radial position of 19.05 mm can be achieved. At a bonding temperature of 750° C. the thermal expansion of the etched discs themselves is between 300 and 400 microns. Disc 910 includes an alignment key 950. Fixture bottom plate 920 includes registration pins 930. Compliant feature 900 is secured to fixture 970 using pins 940 attached to bottom plate 920. Although not shown, it is recognized that compliant features can be integrated into and extend from the bottom plate to form integral compliant features.

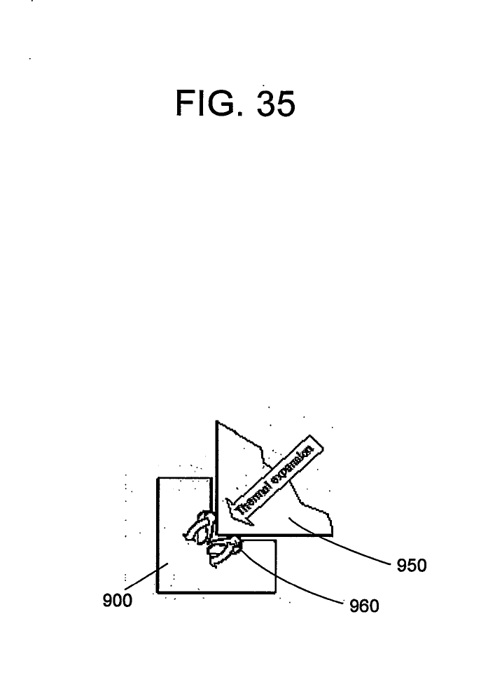

FIG. 35 shows the function of compliant feature 900. Compliant feature 900 includes plural flexible wings 960, which hold alignment key 950 of disc 950 in position and registers the disc prior to bonding. During thermal expansion, wings 960 compensate for laminae expansion by flexing, but still holding the discs aligned. The small registration force applied by wings 960 holds the laminae aligned independent of the bonding temperature.

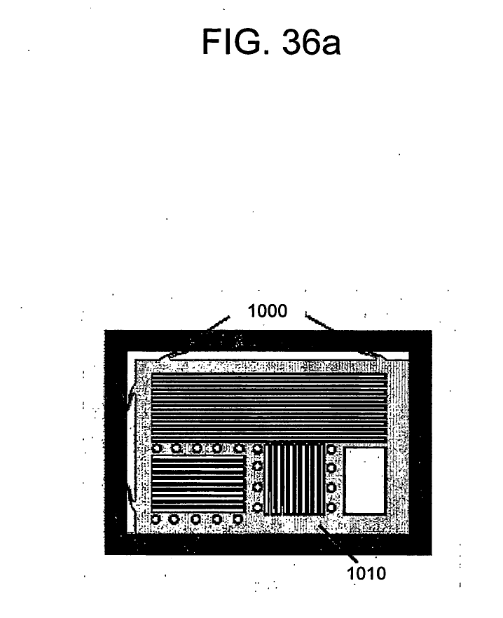

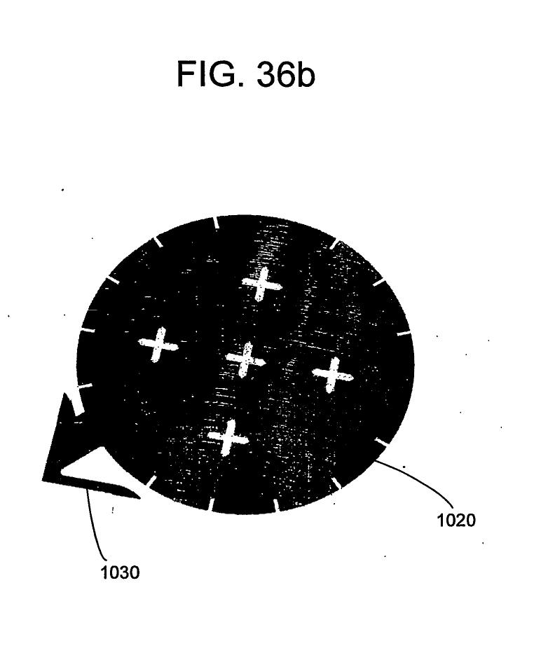

For MECS devices with many laminae, it may become difficult to position compliant features for each layer on or in the fixture. Accordingly, a similar technique using integrated features can be implemented for laminae stacks with a large number of layers. According to one embodiment, integrated compliant features 1000 are integrated into the layer design of a particular MECS device as shown in FIG. 36a for a rectangular shaped laminae 1010, and integrated compliant feature 1030 as illustrated in FIG. 36b for circular or rotational shaped laminae 1020. Accordingly, the thermal registration of MECS devices with many layers can be accomplished. Consequently, a specially designed CTE clamping unit facilitating registration is not required and the alignment is independent of the stack height and fixture design.

Results from experimentation using the compliant feature embodiment shown in FIG. 36b indicate a misalignment of about five microns for laminae stacks is achievable. As shown in FIG. 36b, interior marks 1025 and peripheral marks 1035 patterned on each of five laminae to be bonded were used to verify the amount of registration before and after bonding. The misalignment was detected by using a microscope at 100× magnification and an overlaid video micrometer system.

After the MECS device is bonded the structures simply can be cut away. Another possibility is to design the registration structures in such manner that they can be used to fasten the device.

In another embodiment, integrated compliant features are embedded compliant features. As shown in FIG. 37a for rectangular laminae, two embedded compliant features 1040 are embedded in one side of laminae 1050 and one compliant feature is embedded in another side of laminae 1050. Alternately, as shown in FIG. 37b for circular laminae, embedded compliant feature 1040 and embedded compliant feature 1045 are embedded in lamina 1060. Embedded compliant feature 1045 is designed to prevent roll about an axis perpendicular to the laminae surface. While in one embodiment, laminae 1050 contains one embedded compliant feature 1040 and one embedded compliant feature 1045 as shown in FIG. 37b, other embodiments include laminae with two features 1040, while still other embodiments have laminae with two features 1045.

Prior to bonding, laminae 1050 and 1060 are fully registered using alignment pins 1090 formed in fixture plate 1070 and 1080, respectively, and a combination of embedded compliant features 1040 and/or 1045. During temperature ramp-up and bonding, laminae 1050 and 1060 thermally expand and alignment pins 1090 cause embedded compliant features 1040 and 1045 to flex, which substantially eliminates unwanted warpage an allows the laminae to remain fully registered.

F. Surface Mount Technology (SMT)

Achieving high volume production of MECS devices at a lower cost, using lower bonding temperatures and pressures, and requiring less time, a method utilizing Surface Mount Technology (SMT) for the high volume microlamination production of MECS devices is herein disclosed.

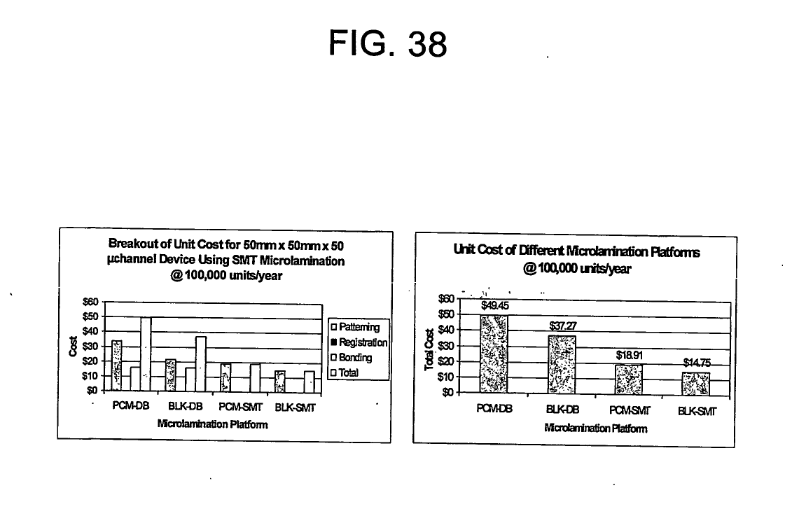

As illustrated in FIG. 38, production of microchannel arrays using surface mount technology (SMT) is more economical when compared to a diffusion bonding approach. The graphs of FIG. 38 are based on the unit cost of a 50 mm×50 mm×50 mm microchannel array device assuming a production rate of 100,000 units/year. The dominant expenses (patterning, registration and bonding) making up the total unit cost for four different microlamination platforms is shown. The represented platforms consisting of combinations of the following: photochemical machining (PCM), blanking (BLK), diffusion bonding (DB) and surface mount technology (SMT). As illustrated in the graphs, the total unit cost for a microchannel array device using SMT techniques is nearly 50% of the total unit cost for devices produced using diffusion bonding techniques. This is mainly because the only dominant expense incurred in the production of microchannel devices using SMT techniques is patterning costs.

In addition to being an efficient, economical platform for production, SMT also provides a platform for integrating electronics into MECS devices. This factor may become more critical as the need to integrate sensors and actuators within MECS devices grows.

One microlamination technique disclosed in the present application involves printing layers of solder as channel laminae onto fin laminae using solder printing techniques and then reflowing the solder layers through a conveyorized convection oven. Another technique involves printing layers of solder onto channel laminae (i.e. spacers) and fin laminae using solder printing techniques and then reflowing the solder layers through a conveyorized convection oven.

Several mechanisms exist for constraining the flow of solder during reflow to prevent wicking into adjacent microchannels. The first mechanism involves the use of a channel “spacer” that essentially constrains the wetting behavior of the solder through the use of a hard edge. Essentially, when the solder reaches the extent of spacer dimensions, the solder stops. A second mechanism for constraining the flow of solder involves the manipulation of surface chemistry on fin laminae adjacent to microchannels. By controlling the surface chemistry (e.g. metal oxides) of these laminae, the wettability of the material can be controlled. By increasing contact angles of the solder melt, the solder will not wet sections of the laminae directly adjacent to microchannel sections. Finally, flow of the solder along the fin laminae is also constrained by the surface tension of the solder as constrained by the edge of the channel spacer.

SMT techniques can be used to achieve high volume production of MECS devices at lower bonding temperatures and pressures, and in less time. The bonding process in SMT requires a low temperature (most solder reflow below about 300° C.) and occurs at atmospheric pressure. Low fabrication temperatures and pressures prevent warpage and residual stress in materials, leading to a more stable geometry and better alignment. Furthermore, the reflow process for a 4×4 inch PCB usually takes less than 1 minute, for a five zone reflow oven. The amount of time required for reflow is therefore negligible when compared to other bonding techniques, such as diffusion bonding, which may require hours to bond the laminae. Finally, since the printing and reflow process can easily be automated with minimum human interaction, using SMT techniques for making MECS devices is well suited for high volume production.

Producing MECS devices using SMT technology generally includes at least four processes: patterning, cleaning and micro-etching, registration and reflow.

1. Patterning

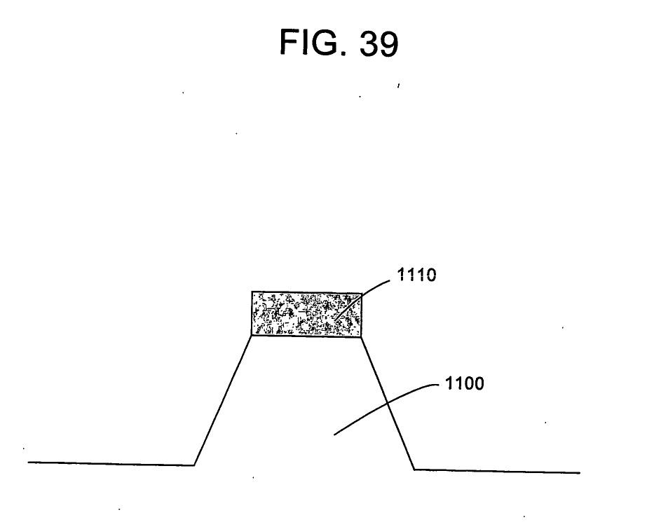

Laminae patterning is the process of shaping laminae into geometries useful for implementation into a microlaminated device. Patterning the laminae can be done by embossing, stamping, powder injection molding, laser machining or otherwise forming or molding a metal alloy, polymer, ceramic or composite laminae substrate. Such patterning can facilitate various geometries that, in conjunction with SMT, can be used to improve MECS devices. FIG. 39 illustrates an exemplary geometry that can be formed using these patterning processes. The geometry of substrate 1100 can eliminate the need for external channels, while still holding the solder 1110 within a required area due to surface tension phenomenon. One known advantage of the geometry of FIG. 39 is that the functionality of fin laminae and channel laminae, which are typically separate lamina in diffusion bonded MECS devices, can be combined into one lamina with SMT bonded MECS devices.

Materials useful for producing monolithic devices with SMT bonding generally are materials that have low density, low specific heat and high thermal conductivity, with good machinability, formability, moldability and solderability. Exemplary materials include, but are not limited to, aluminum, nickel-plated aluminum, titanium and copper.

The patterning process may require deburring and flattening of the laminae prior to cleaning and micro-etching. Flattening each lamina can assist in solder paste printing and solder filling during the reflow process, as well as achieving MECS device channels of uniform height.

2. Micro-etching

Micro-etching the laminae prior to bonding promotes enhanced solder wetting characteristics and helps control the flow of solder during reflow by facilitating surface tension. Micro-etching removes contaminants and rough adherend surfaces on lamina that tend to restrict surface tension. Consequently, through micro-etching, the ability to direct the solder within the device to desired locations is achieved. In this way, the solder can be used to define structure, which is not the case in PCB fabrication and electronic assembly. And, a level of feature resolution necessary to make complex MECS devices also is achieved.

It is expected that two mechanisms exist for constraining the flow of solder along the fin laminae during reflow so that it does not wick into adjacent microchannels. The first mechanism for constraining the flow of solder involves the manipulation of surface chemistry on fin laminae adjacent to microchannels. By controlling the surface chemistry (e.g. metal oxides) of these laminae through micro-etching, the wettability of the material can be controlled. By increasing contact angles of the solder melt, the solder will not readily wet sections of the laminae directly adjacent to microchannel sections. Second, flow of the solder along the fin laminae is also constrained by the surface tension of the solder as constrained by the edge of the channel spacer.

Micro-etching of laminae can be performed following conventional circuit board industry techniques, such as plasma etching, chemical etching, and corona oxidation. For example, masked laminae can be bathed with etchants by using an etchant bath or etchants can be swapped onto the laminae. One example of a suitable etchant fluid mixture is an aqueous hydroxide/peroxide composition. A more specific etchant fluid was 10% ammonium hydroxide and 3% hydrogen peroxide.

Generally, following a micro-etching process, laminae are washed with deionized water to remove any excess solution.

3. Registration

Registration can be done with the conventional pick and place machines that are used for mounting components in SMT platforms. This way laminae can be stacked (instead of components) in a prepared order onto a mixture.

4. Solder Printing and Reflow

Solder paste according to one embodiment of the present application should possess good mechanical, thermal and chemical properties. Furthermore, an inexpensive solder paste would be economical when mass producing MECS devices. Because MECS devices may be used in high temperature applications, solder pastes with reflow temperatures in excess of 250° C. may be preferred, although solder pastes with lower reflow temperatures can be used. Examples of useful solder pastes include, but are not limited to, Sn95-Sb5, Sn10-Pb90 and Sn10-Pb88-Ag02.

In other embodiments, braze pastes within microlaminated architectures can be used for making MECS-type devices of all sizes and shapes. Braze-paste technology can be used for economical bonding of intermetallics, such as NiAl, for intermetallic microchannel arrays used in high temperature applications. According to yet another embodiment, glass pastes can be used to sinter together ceramic substrates used in high temperatures applications.

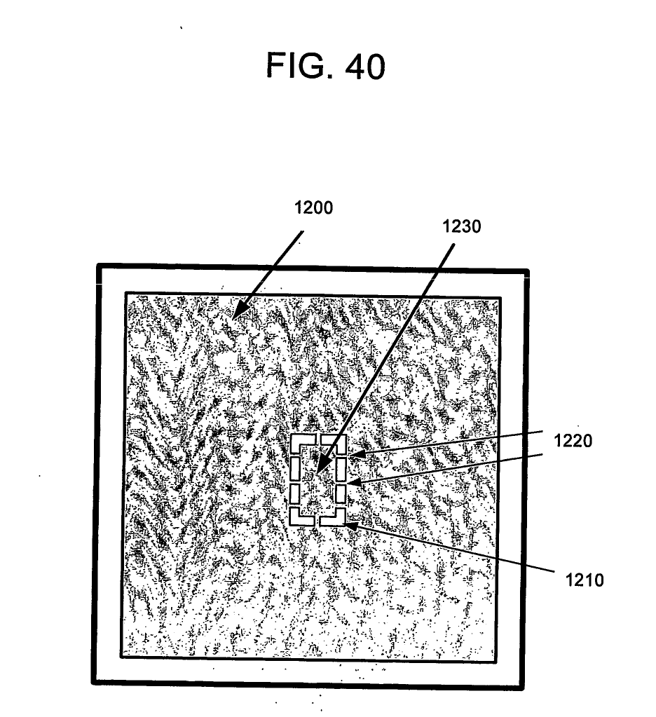

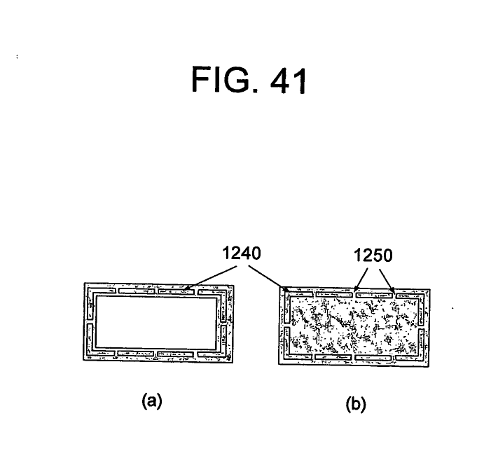

Using solder paste as an example, although other pastes may be used, solder paste is printed on the cleaned and micro-etched laminae prior to reflow. Stencil 1200 can be used to apply the solder paste (FIG. 40). The stencil has etched openings 1210 separated by tie bars 1220 forming a solder paste design pattern. Tie bars 1220 are small metal connections left on the stencil to retain the inner portion of the stencil to the outer portion. Solder paste is then dispensed onto the laminae through the openings in the stencil. FIG. 41a shows the printed solder paste 1240 and tie-bar spaces 1250 on a spacer lamina and FIG. 41b shows printed solder paste on an end cap lamina. Low-residue no-clean flux can be applied at the tie-bar spaces to provide greater surface tension for solder to flow into the tie bar spaces after the device is reflowed.

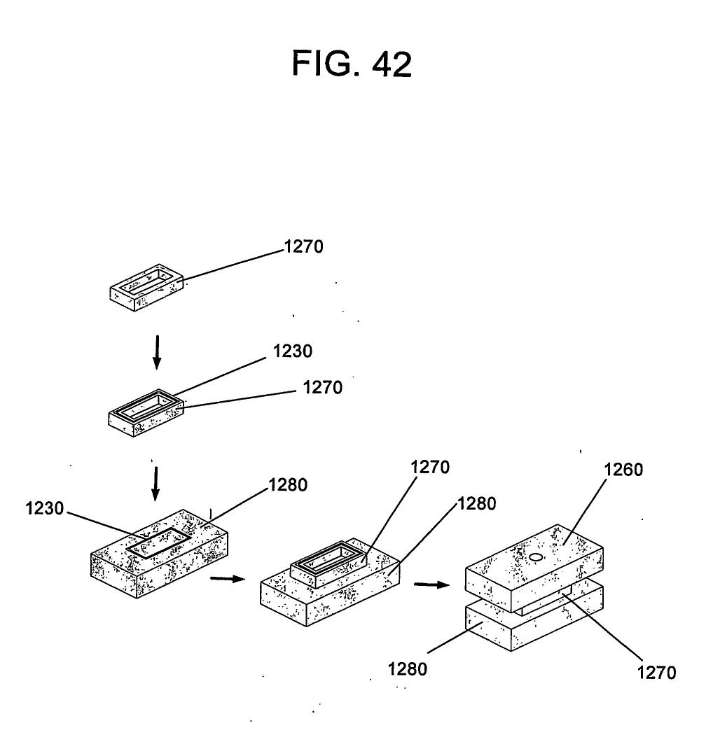

Spacer lamina 1270, end cap lamina 1280 and interface plate lamina 1260, with printed solder paste 1230 are stacked in the desired order to form an array with interface plate 1260 (FIG. 42). The laminae are then registered using the techniques described above and placed in a conveyorized oven. To maintain contact between the solder paste and the laminae, a nominal application of pressure is applied to the laminae. The laminae array is then heated up such that reflow occurs and a bond is achieved.

The reflow oven needed for this application may need to be longer in length, and also may be able to reach higher temperatures, than the ones used in conventional SMT platforms (see FIG. 4). This is due to the potential to use materials with higher enthalpies in MECS devices.

For more uniform distribution of heat during reflow, using the internal plumbing inherent to microchannel devices, and raising the internal temperature of the device using forced convection, are beneficial. Forced convection helps reach thermal equilibrium of the device in a shorter time period.

A working example is provided below for microchannel arrays using Cu substrates and SnPb solder. This fabrication architecture would be potentially useful for making an expander/compressor cycle, micro-scale heat pump. This example is provided to illustrate certain features of a working embodiment. The scope of the disclosed embodiments should not be limited to the particular features exemplified.

### EXAMPLE 2

Experimental designs were applied to prove the functionality of using SMT techniques for high volume production of microlamination devices. Particularly, special test articles were designed to determine the predictability of the article channel heights through metallographic analysis and the bond quality through leakage tests. The following setup and experimental results confirm the advantages of using SMT techniques to mass produce highly parallel, high-aspect ratio microchannel arrays.

1. Setup

Copper shim stock having a thickness of 203 μm (0.008 inches) was used to produce the test articles for the conducted experiments. The shim stock used was made from alloy 110 copper (99.9% copper). Kester-256 no-clean tin-lead eutectic solder alloy (Sn63-Pb37) was used for the bonding of laminae and low-residue, no-clean flux was used for localized wetting of the copper where solder paste was not applied but was required to wet the surface.

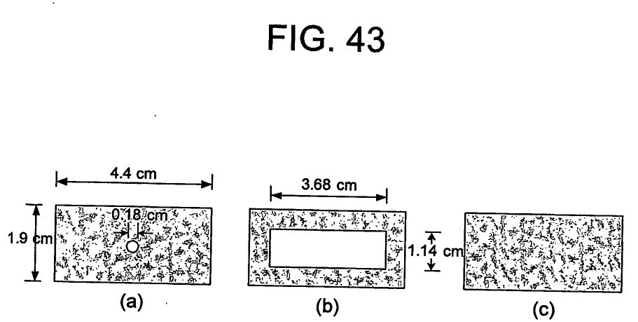

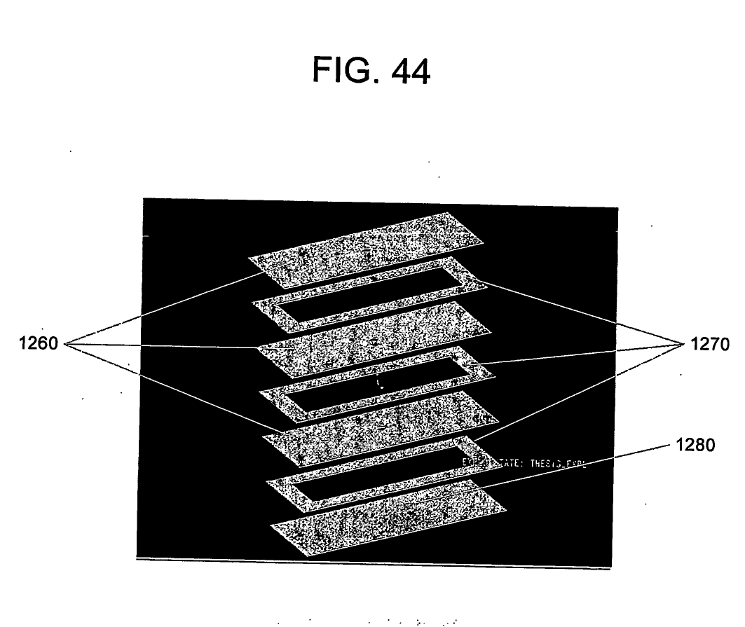

The test article was a stack of seven copper laminae each having a width of 4.4 centimeters and a height of 1.9 centimeters, respectively. Three different lamina geometries were used in the test device. The geometries included an interface plate (FIG. 43a), spacers/channels (FIG. 43b), and an end cap (FIG. 43c). The geometry of each of the seven laminae making up the device and well as the laminae arrangement are shown in FIG. 44. The interface plate 1260 allows interconnection with the test loop and the spacer 1270 acts as a microchamber for testing leakage. The spacer 1270 also functions to provide additional control of the solder wetting behavior during reflow. Furthermore, the test articles were designed to have microchannels with aspect ratios of 42:1.

A 355 nm Nd:YAG laser mounted on an ESI 4420 laser micromachining system was used to pattern the copper shims into laminae of the required geometry. The laser was programmed for cutting each lamina using standard G-codes. Scotch Brite was used for the mechanical removal of burrs produced during the cutting process. The laser burr height was measured on three samples before and after the mechanical deburring treatment, using a Dektak³ profiler. The laser burrs were reduced from 19.1±8.5 μm before the treatment to 2.93±2.3 μm after the treatment.

A vacuum hot press was used for flattening the laminae. Flattening involved sandwiching the laminae between thin, flat graphite plates and placed one over the other to form an array. This array of alternate graphite and copper lamina was loaded in the hot press and heated to a temperature of 500° C. for 30 minutes while applying a flattening pressure of 36.75 bars within a vacuum environment of about 1×10⁻⁴ mbar. Three different laminae samples were measured for their surface flatness before and after the flattening process. The Dektak³ profiler was again used to measure the surface flatness. The flattening process reduced the surface flatness of the Cu laminae from 99.9±32.9 μm (fresh from vendor) to 4.73±1.14 μm.

Flattened laminae were micro-etched over a localized area where solder paste should flow. Micro etching was done using a ˜10% ammonium hydroxide and 3% hydrogen peroxide solution. The micro-etched laminae were then washed using deionized water.

Solder paste was printed on the end caps, fins and the channels. Low residue, no-clean flux was applied (with the help of a small needle pin) at the tie-bar area When solder paste is printed onto the substrate using this stencil, tie bar spaces were transferred to the substrate as uncovered solder paste area. An Ekra, semi-automatic screen printer with metallic squeegee blades was used for the solder paste printing.

The solder paste printed laminae were stacked together in the order shown in FIG. 44 (end caps at bottom, fins with alternating layer of spacers between and an interface plate at top) to form an array. This array was placed on a graphite fixture, and edge aligned at one end. A graphite shim was applied on the array to provide uniform distribution of a slight bonding pressure on the device of about 0.05 to 0.2 bar (˜1 to 2 psi).

The laminae array and graphite weight were placed in the hot press for reflow. The hot press temperature was ramped at a rate of 20° C. per minute to a temperature of 365° C. for two minutes. The heating cycle was run in a vacuum of about 1×10⁻⁴ mbar, which was found to facilitate the degassing of the solder paste and thus prevent post-bonding voids. When the peak temperature was reached, the hot press was cooled by introducing 99% helium gas in the vacuum chamber. Varying weights can be applied on the device during the reflow process when run on a hot press.

Once reflowed, the devices were removed from the hot press. Half of the devices were subjected to measurement analysis to determine the actual height of the microchannels and half were checked for leakage. Channel height is defined by the thickness of the spacer and the volume of solder paste after reflow. Metallography was performed on the device to observe a cross section of the microchannels in an effort to verify the channel height. The metallography of a 3-layered device was done by molding it in epoxy resin. After hardening of the resin, the device was sectioned and polished to observe the flatness and parallelism of the channels and also to measure the channel heights. All of the measurements were taken using a video micrometer at 50× magnification on an optical microscope. The resolution of the microscope used for these measurements is 2 μm at a magnification of 50×.

After measuring the actual channel heights of half of the devices, the measurements were then compared to theoretical microchannel heights obtained from the mathematical model described forthwith.

Since channel height non-uniformity typically reduces the performance of a MECS device, channel height characteristics of the tested devices was measured. With SMT bonded MECS devices, the solder and the channel laminae provide the necessary channel height. A mathematical model was derived to predict the height of channels in the device using device geometries.

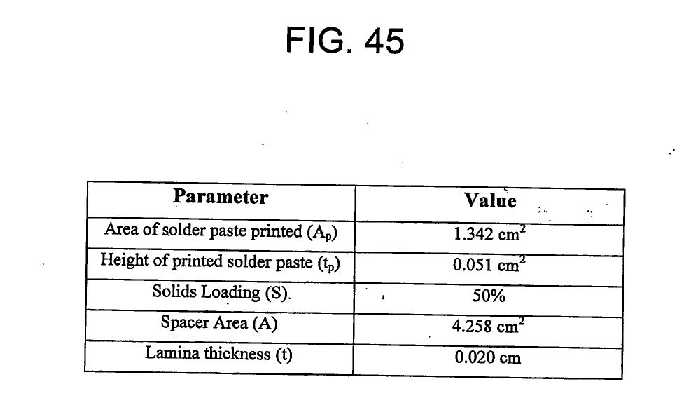

The volume of solder paste printed onto the lamina (Vₚ) is given by the equation:
Vₚ=Aₚ·tₚ (23)
where, Aₚ is the upward facing solder paste area (i.e. height times width) as shown in FIGS. 41a and 41b, and, tₚ is the height (i.e. thickness) of the printed solder paste (i.e. the stencil thickness). The volume of solder after reflow (Vs) is therefore:
Vₛ=Vₚ·S (24)
where, Vₚ is obtained from Equation 23, and S is the solids loading of the solder paste. Solids loading is the metal content of a solder paste, expressed in percentage by volume. The resulting solder thickness, tₛ can be predicted using equations 23 and 24 as follows:

$${t}_{s} = \frac{{V}_{s}}{A} \qquad ( 25 )$$

where A is the up-facing area of the channel/spacer lamina (FIG. 41a). The resulting channel height, h, can be obtained from the following summation:
h=t+2tₛ (26)
where t is the lamina thickness. Values for calculating the theoretical channel height are shown in FIG. 45.

The devices not measured for channel height were tested for bond quality by performing a leakage test. A leak-proof hermetic bond is a required condition for all microfluidic devices. To perform the leak test, the MECS devices were connected to an air supply source. The devices were then immersed in water and leakage was checked by watching for the formation of air bubbles for up to one minute.

2. Channel Height Results

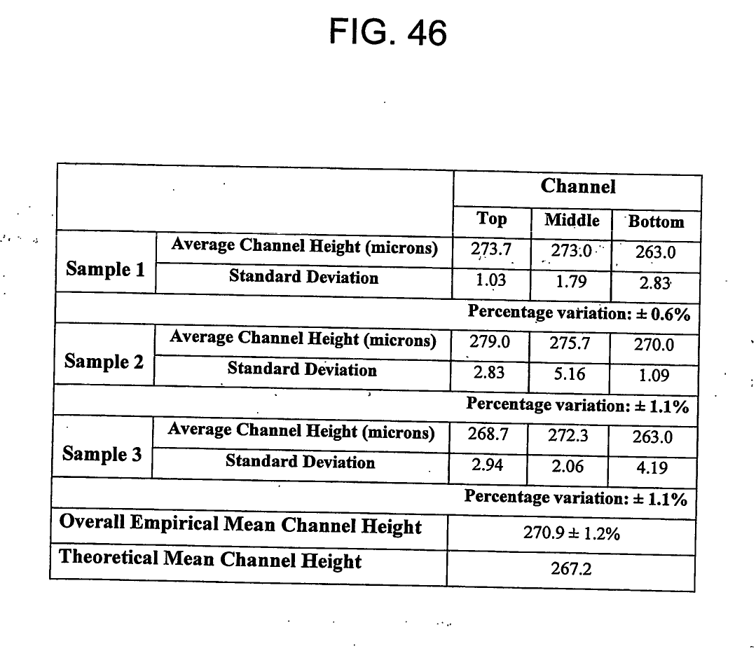

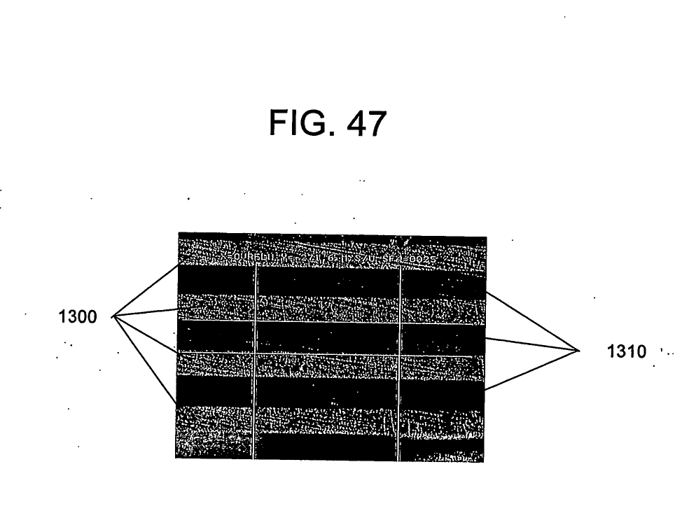

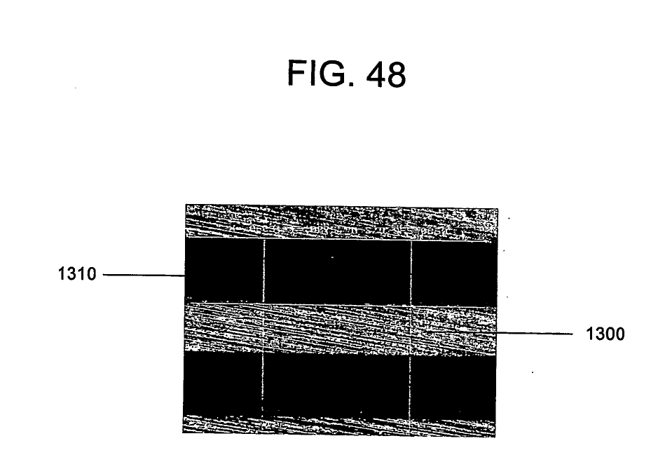

Three of the devices were checked for channel height with each device having three channels. The average top, middle and bottom channel heights as measured and the standard deviation for the three samples are shown in FIG. 46. FIGS. 47 and 48 illustrate a cross-section of one of the microchannel array devices fabricated for testing the channel height. FIG. 47 showing a 25× magnification of the device and FIG. 48 showing a 50× magnification.

As shown in FIG. 46, the measured overall mean channel height was 270.9 μm and the standard deviation was 3.19 μm for the three devices, which translated into an overall percent variation in the channel height for the three devices of ±1.2%. The percentage variation in channel height for the three individual samples was calculated to be ±0.6%, ±1.1%, and ±1.1% respectively. The average percentage variation in channel height for the top, middle and bottom channels was calculated to be ±0.8%, ±1.1%, and ±1.0% respectively. These minor differences in channel heights may have been due to a combination of factors including variation in lamina flatness, bending of laminae during micro-etching, or variation in any of the parameters included in Equations 23-26.

The microchannel variation resulting from this process is insignificant when compared to devices produced via diffusion bonding. Typical channel height deviations within diffusion bonded stainless steel devices have been found to be from 31.7% to 7.7% for channel heights from 50.8 μm to 1010.6 μm respectively. For microchannels made out of NiAl, deviations between 21% to 37% have been found. Past studies have shown that a 20% channel deviation will result in about a 50% increase in the number of channels needed for a typical microchannel heat exchanger. These results show that MECS devices fabricated using SMT bonding techniques have lower channel height deviations than in diffusion bonded MECS devices and therefore less channels are needed, which results in more efficient and less expensive devices.

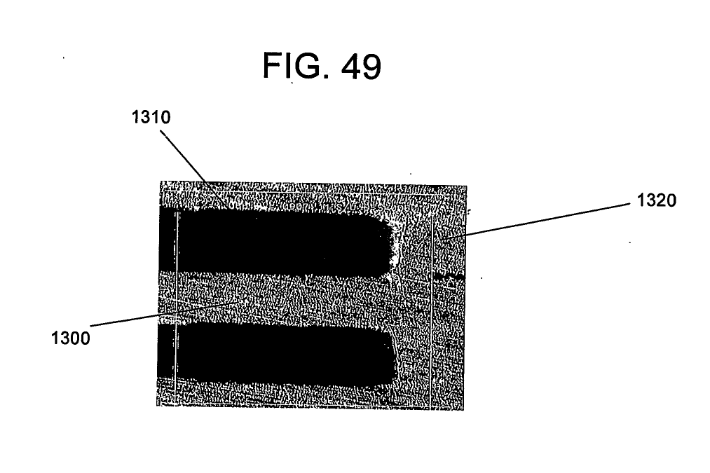

A further result of testing for microchannel height was substantiation of the ability to control the reflow process adjacent to microchannels. Control of the reflow process was indicated by generally good agreement between the measured channel heights and the heights predicted by the theoretical model. In other words, during reflow, solder 1320 was substantially restricted from entering the microchannels 1310 as shown in FIG. 49. The predicted channel height was found to be 267.2 μm which is just outside the 95% confidence interval of 267.6 to 274.3 μm. This result provides strong evidence that the micro-etching process and the channel/spacer laminae were helpful for restricting the flow of solder during reflow.

3. Leakage Results

Results of the leakage tests showed good bond quality in the devices. The devices pressurized to an air pressure of 1.72 bar (25 psi) and, with no detection of air bubbles were found to be hermetically sealed. In other words, MECS devices produced using SMT bonding techniques had sealing and bonding properties that at least match devices produced using other bonding techniques, such as diffusion bonding.

H. Pre-Bonding Methods for Microlamination of Microfluidic Devices

Lamina warpage and channel collapse have been investigated within high aspect ratio microchannels. As has been described herein, diffusion bonding laminae requires a uniform bonding pressure applied to the laminae stack at an elevated temperature. Pressures applied below the bonding temperature cause the laminae to remain unbonded in certain regions and when applied to regions adjacent to the channel cause elastic compression of the laminae stack in the regions where the pressure is applied, as well as regions immediately adjacent leading to channel collapse. Furthermore, where temperature gradients exist within the fins, fin warpage may result.

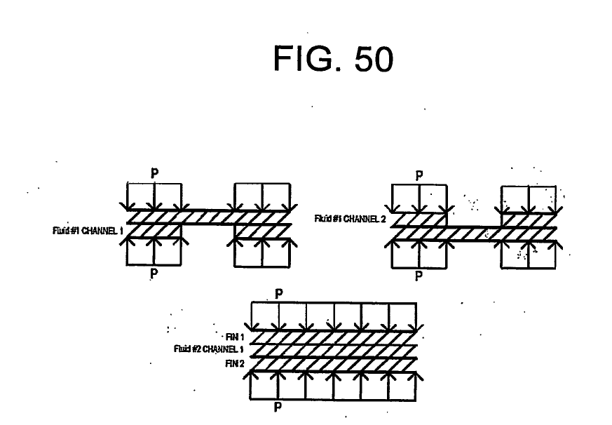

Because of channel collapse fin warpage when bonding microchannel in a single step, a fin aspect ratio limit exists. An approach to exceeding this limit is to tack bond subsections of the laminae stack prior to final bonding. This pre-bonding technique subverts any issues associated with single-sided force distributions on shims. A set of pre-bonded substructures, such as shown in FIG. 50, which could be subsequently bonded to form the final geometry.

The approach would require two bonding cycles. The first cycle would be a tack bonding cycle of all separate subsections (FIG. 50). The purpose of this cycle would be to ensure that all areas of the laminae to be bonded had intimate contact. The tack bonding cycle could be accomplished with a variety of bonding and welding techniques. According to certain embodiments, diffusion bonding and resistance spot welding techniques could be used. The second cycle includes bonding all subsections together, including strengthening the tack bonded welds. If necessary, further cycles could be performed to bond further subsections.

Pre-bonding methods can effectively produce high-aspect-ratio channels (>100:1) in NiAl channels formed using reactive diffusion of elemental foils. Full pore elimination in the pre-bonding cycle is not necessary to insure a void-free bond over fin regions. The purpose of the pre-bonding cycle is simply to perform first stage deformation and interfacial boundary formation between laminae. Pore elimination in these regions happens by grain boundary and volume diffusion during the second bonding cycle. Pre-bonding cycles based on diffusion bonding as short as 15 minutes have been found adequate to provide interfacial boundary formation in diffusion-bonded laminae.

I. Internal Convective Heating and Cooling to Minimize Non-Uniform Thermal Distribution

Non-uniform thermal distribution can slow heating and cooling rates and result in longer cycle times. One embodiment of the disclosed method that takes advantage of the fluidic nature of the devices being processed to increase heating and cooling rates during manufacturing of MECS devices. This embodiment includes a fixture and flow loop that permits inert gases to be passed through the existing channels in the device during the bonding process. This allows thermal energy to be transferred to the interior of the device by convection, in addition to the radiant energy being transferred to the surface of the device. The addition of thermal energy by convection to the interior of the device significantly reduces thermal gradients in the device and leads to improved bonding processes.

The bonding process typically relies on conduction to move thermal energy from the surface of the device to the fins and then along the fins. Conduction requires a temperature gradient to transfer thermal energy from the hot center of the fin to the root of the fin (assuming cool down). In a thin fin, this can require a significant thermal gradient, which in turn can lead to thermally induced warpage.

Internal convection adds thermal energy directly to the complete length of the fin and does not require a temperature gradient along the fin. The advantages of internal convective heat transfer include: 1) transfer of thermal energy to/from a fin by convection from the heat transfer gas, reducing thermal gradients along the fin and hopefully reducing thermally induced warpage; 2) reducing thermal gradients during both the heat up and cool down processes; and 3) in addition to minimizing thermal stresses and further increasing the fin aspect ratio, significantly speeding up the bonding cycle, which may be a concern for economical production.

An inert heat transfer gas including, but not limited to, argon, helium, nitrogen and mixtures of such gases, is introduced into the existing channels in the device. During heat up, the gas will be slightly hotter then the device and heat will be transferred from the gas to the metal fins forming the interior channels. Similarly, during cool down inert gas is introduced into the device at a temperature slightly lower then the temperature of the device. In both cases the high rates of heat transfer attainable in microchannels allow the rapid addition (or removal) of thermal energy to the inside surfaces of the embedded microchannels.

In one particular fixture embodiment using a gas/liquid expander, such as one shown in FIG. 33, inert gas contained in the bellows can be introduced into the channels of the device to facilitate the cooling and/or heating processes. In the case of heating, excessive pressurized fluid will flow through the unbonded microchannel device during the initial part of the thermal cycle. This fluid would be added above and beyond that required for bonding and would be released through a pressure relief valve during the cycle. For cooling, a station could be implemented at the end of the furnace cycle in which cooled fluid would be pumped through the monolithic device to bring down the internal and external temperature of the device simultaneously. This would increase cycles will eliminating unwanted residual stresses. During bonding, the fluid would presumably leak out of the unbonded device. During cool down, the fluid would flow into and out of the device through appropriate interconnects that could be designed into the fixtures. The inlet interconnect could be the same as the pressure relief valve.

The mass flow rate of the heat transfer gas must also be minimized so that the velocity and pressure drop associated with the gas is acceptable. The required mass transfer depends on the selection of the gas, the gas pressure, the length of the device and the allowable gas temperature change (the difference between the inlet and exit temperature of the gas). In addition, convection to and from the gas should be sufficiently high so as to not be a significant limitation on the process.

The present invention has been described with reference to particular embodiments. A person of ordinary skill will recognize that the invention is not limited to the specific features described.

### REFERENCES INCORPORATED HEREIN BY REFERENCE

1. N. Sharma, J. D. Porter, B. K. Paul, “Understanding Cost Drivers in Microlamination Approaches to Microsystem Development,” IIE IERC, Portland, Oreg., May 17-21, 2003.
2. N. Sharma, B. K. Paul, “The Application of Surface Mount Technology to Multi-Scale Process Intensification,” ASPE, Portland, Oreg., October 28-29, 2003
3. B. K. Paul, H. Hasan, J. S. Thomas, R. D. Wilson, D. Alnan, “Limits on Aspect Ratio in Two-Fluid, Micro-Scale Heat Exchangers,” NAMRC, Gainesville, Fla., May 22-25, 2001.
4. Paul, B. K., H. Hasan, T. Dewey, D. Alman, and R. D. Wilson, “An Evaluation of Two Methods for Producing Intermetallic Microchannels,” accepted for publication in ASME International Mechanical Engineering Congress and Exposition, New Orleans, La., 2002.
5. Ahnan, D. E., RD. Wilson, and B. K. Paul, “Fabrication of NiAI Intermetallic Reactors for Microtechnology-based Energy and Chemical Systems,” Transactions of NAMRC XXIX; Gainesville, Fla., 2001.
6. Paul, B. K., H. Hasan, T. Dewey, D. Alman, and R. D. Wilson, “Development of Aluminide Microchannel Arrays for High-Temperature Microreactors and Micro-scale Heat Exchangers,” 6th Int. Con! Microreaction Tech., New Orleans, La., March 10-14, 2002.
7. Paul, B. K., T. Dewey, D. Alman and R. D. Wilson, “Intermetallic Microlamination for High-Temperature Reactors,” 4th Int. Con. Microreaction Tech., Atlanta, Ga., March 5-9, 2000.
8. Welding Handbook: Resistance and solid-state welding and other joining processes, W. H. Kearns, ed., American Welding Society, Miami, Fla., 1980.

A variety of micro fluidic devices have been developed within the MSF Laboratory in miniaturization applications including, but not limited to the following:
9. Paul, B. K., W. Wangwatcharakul and C. Wu, “A micro-ball-float valve for biological tissue-based micro fluidic systems,” accepted by J. Design Mfg Automation.
10. Paul, B. K., C. Arampongphun, F. Chaplen and R. Upson. 2002. “An Evaluation of Materials and Processing Methods for Tissue-based Microsystems,” submitted to Transactions of NAMRC XXXI, Hamilton, Ontario, Canada, May 20-23.
11. Paul, B. K., H. Hasan, T. Dewey, D. Alman, and R. D. Wilson, “An Evaluation of Two Methods for Producing Intermetallic Microchannels,” accepted for publication in ASME International Mechanical Engineering Congress and Exposition, New Orleans, La., 2002.
12. Paul, B. K. and T. Terhaar, “Comparison of two passive microvalve designs for micro lamination architectures,” J Micromech. Microengr., 10: 15-20, 2000. Proprietary 1

In addition to device development, the MSF Laboratory also conducts fundamental research in fabrication science to support future device development. Several past fabrication science projects include:
13. Wattanutchariya, W. and B. K. Paul. 2002. “Bonding Fixture Tolerances for High-Volume Metal Microlamination Based on Fin Buckling and Lamina Misalignment Behavior,” submitted to the J. Itnl. Soc of Precision Engr and Nanotechnology.
14. Thomas, J. and B. K. Paul. 2002. “Thermally-Enhanced Edge Registration (TEER) for Aligning Metallic Microlaminated Devices,” Transactions of NAMRC XXX, West Lafayette, Ind., May 21-24.
15. Paul, B. K., H. Hasan, J. Thomas, R Wilson, and D. Alman, “Limits on Aspect Ratio in Two-fluid Micro-scale Heat Exchangers,” Transactions of NAMRC XXIX, Gainesville, Fla., 2001.
16. Paul, B. K., “An analytical model of the diffusive scattering of low-energy electrons in electron beam resists,” Microelectronic. Engr., 49: 233-244, 1999.

We claim:

1. A thermal expansion clamping unit for bonding laminae together, comprising:
a base plate;
a top plate;
at least one engager positioned between the base plate and top plate; and
at least one spring functionally associated with the unit.

2. The unit according to claim 1 where the at least one spring is positioned between the base plate and the at least one engager.

3. The unit according to claim 2 where the at least one spring is preloaded prior to bonding.

4. The unit according to claim 3 further comprising a load stage positioned between the at least one engager and the at least one spring.

5. The unit according to claim 4 further comprising at least one adjustable fastener retaining the at least one spring and the load stage against the base plate.

6. The unit according to claim 1 where the at least one engager is an expansion cylinder.

7. The unit according to claim 1 where the at least one engager block is a fluid expander.

8. The unit according to claim 7 where the fluid expander comprises a bellows filled with a gas or liquid.

9. The unit according to claim 1 further comprising a first platen positioned between the base plate and the engager, the first platen being adjacent to an upper surface of a laminae to be bonded.

10. The unit according to claim 9 further comprising a second platen positioned between the base plate and the engager, the second platen being adjacent to a lower surface of a laminae to be bonded.

11. The unit according to claim 10 where the first platen and second platen are made from graphite or a ceramic material.

12. The unit according to claim 1 where the top plate and bottom plate are made from a ceramic material and the engager is made from metal.

13. The unit according to claim 1 where the top plate comprises at least one adjustable set screw positioned above the at least one engager, the set screw being adjustably raised or lowered to define an initial gap setting.

14. The unit according to claim 13 where the at least one engager comprises plural engagers, wherein an at least one adjustable set screw is positioned above each of the plural engagers.

15. The unit according to claim 1 where the at least one engager comprises at least five engagers.

16. The unit according to claim 1 where the at least one engager comprises at least seven engagers.

17. A method for bonding laminae together to form a device, comprising:
providing a thermally assisted bonding unit having at least one pressure regulating spring; and
bonding laminae together using the device.

18. The method according to claim 17 where bonding comprises continuously bonding workpieces using plural, thermally assisted bonding units.

19. The method according to claim 17 further comprising using a conveyorized furnace for applying heat to laminae functionally associated with the bonding unit.

20. The method according to claim 17 further comprising forced convective heating of the laminae, forced convective cooling of the laminae or both, using a gas.

21. The method according to claim 20 where the gas is an inert gas.

22. The method of claim 20 where the gas is contained in the unit.

23. The method according to claim 17 further comprising thermally registering plural lamina using a registration fixture prior to bonding laminae.

24. The method according to claim 23 where the registration fixture includes flexible laminae engagement portions that flex when displaced by expanding laminae.

25. The method according to claim 24 where at least one lamina in a stack includes a thermal registration element.

26. The method according to claim 25 where the registration element is integral with the lamina.

27. The method according to claim 26 where integral with the lamina comprises embedded in the lamina.

28. The method according to claim 25 where plural laminae include registration elements.

29. The method according to claim 17 where the thermally assisted bonding unit further includes a bottom plate, a top plate and at least one engager positioned between the bottom plate and the top plate.

30. The method according to claim 29 where the at least one pressure regulating spring is positioned between the bottom plate and the at least one engager and laminae is positioned between the at least one pressure regulating spring and the at least one engager.

31. The method according to claim 30 where bonding laminae comprises applying bonding pressure stored in the at least one spring to laminae.

32. The method according to claim 30 where bonding laminae comprises heating the thermally assisted bonding unit, the heat causing the engager to expand relative to the top plate and bottom plate such that at a given time after heating, the engager engages both the top plate and laminae.

33. The method according to claim 32 where at the time the engager engages both the top plate and laminae, final bonding pressure stored in the at least one spring is applied to laminae.

34. The method of claim 17 where bonding laminae comprises prebonding a first stack of at least two laminae and prebonding a second stack of at least two laminae, the first stack and the second stack being subsequently bonded together.

35. A method for bonding laminae together to form a device, comprising:
providing a thermally assisted bonding device;
functionally associating laminae with the device; and
continuously bonding laminae together using the device and a conveyorized heating system.

36. The method according to claim 35 where bonding comprises forced convective heating, cooling or both.

37. The method according to claim 36 where convective heating and/or cooling is accomplished using forced inert gas flush.

38. The method according to claim 35 where functionally associating comprises stacking and registering the laminae on the device.

39. The method according to claim 38 where registering comprises thermally assisted registration.

40. The method according to claim 39 where thermally assisted registration comprises a registration device or lamina having a compliant registration element.

41. A thermal expansion bonding fixture for bonding laminae together to form a device, comprising:
a base plate;
a cylinder mounting plate having plural expansion cylinders; and
a pressure distribution plate positioned between the base plate and the cylinder mounting plate.

42. The fixture according to claim 41 having expansion cylinders of different lengths for differential application of pressure to a workpiece.

43. The fixture according to claim 41 including expansion cylinders made from materials having different coefficients of thermal expansion.

44. The fixture according to claim 41 further comprising spring biased expansion cylinders.

45. The fixture according to claim 44 having plural spring-biased expansion cylinders, at least a first cylinder and a second cylinder having different spring constants.

46. The fixture according to claim 41 wherein the base plate, cylinder plate and pressure distribution plate are made from a ceramic material, and the expansion cylinders are made from a metal.

47. A thermal expansion bonding device for bonding laminae together, comprising:
a frame having a base plate, at least two upright arms and an open top; and
an engager positioned within the frame;
wherein pressure exerted on the arms via thermal expansion of the engager is decomposed into a horizontal pressure component and a vertical pressure component.

48. The device according to claim 47 wherein only the vertical pressure component is transferred to the laminae.

49. A registration device for registering laminae, comprising:
a flexible compliant feature; and
a bonding fixture;
wherein during thermal expansion of the laminae the flexible compliant feature flexes against the laminae or bonding fixture.

50. The device according to claim 49 where the flexible compliant feature is removably attached to or integral with the bonding fixture and during thermal expansion of the laminae the flexible compliant feature flexes against the laminae.

51. The device according to claim 49 where the flexible compliant feature is integrated with the laminae and during thermal expansion of the laminae the flexible compliant feature flexes against the bonding fixture.

52. The device according to claim 51 where the flexible compliant feature is embedded in the laminae.

53. A method for registering laminae, comprising:
providing a registration device having a flexible compliant feature and a bonding fixture; and
registering the laminae using the flexible compliant feature;
wherein during thermal expansion of the laminae the flexible compliant feature flexes against the laminae or bonding fixture.

54. The method of claim 53 where the flexible compliant feature is removably attached to or integral with the bonding fixture and during thermal expansion of the laminae the flexible compliant feature flexes against the laminae.

55. The method of claim 53 where the flexible compliant feature is integral with the laminae and during thermal expansion of the laminae the flexible compliant feature flexes against the bonding fixture.

56. The method of claim 55 where the flexible compliant feature is embedded in the laminae.

57. A method for manufacturing a MECS device, comprising:
forming a plurality of intermettalic laminae;
registering the plurality of laminae using integral compliant features; and
bonding the plurality of laminae together using a thermally assisted bonding device having a pressure regulating spring.

58. A solder paste method for bonding laminae together to define a MECS device, comprising:
providing laminae to be bonded that do not include a solder mask;
microetching at least a portion of at least one lamina in a bonding region selected to receive solder paste;
applying solder paste to a microetched portion; and
bonding laminae using the solder paste.

59. The method of claim 58 where laminae comprises at least one spacer lamina.

60. The method of claim 58 where microetching comprises plasma etching, chemical etching or corona oxidation.

61. A method for making a microlaminated device, comprising:
bonding a first stack of laminae using a thermal expansion bonding unit;
bonding a second stack of laminae using solder paste techniques; and
bonding the first stack of laminae to the second stack of laminae to form a third stack of laminae.

62. The method of claim 61 further comprising registering the first stack of laminae using a compliant feature.

63. The method of claim 62 further comprising prebonding at least two lamina of the first stack of laminae or prebonding at least two lamina of the second stack of laminae.

64. The method of claim 63 further comprising forced convective heating of the laminae, forced convective cooling of the laminae or both, using a gas.

65. A thermal expansion clamping unit for bonding laminae together, comprising:
a frame having a base plate, a top plate and support rods positioned between the base plate and the top plate, the support rods coupling the top plate and bottom plate;
at least one engager positioned between the base plate and top plate;
a first platen and a second platen positioned between the at least one engager and the bottom plate, the first platen contacting an upper surface of the laminae and the second platen contacting a lower surface of the laminae;
a load stage positioned between the second platen and the bottom plate;
a spring positioned between the load stage and the bottom plate;
a fastener compressively retaining the load stage and the spring to the bottom plate, the spring storing a compressive force; and
a gap height adjustment screw coupled to the top plate, a space between the gap height adjustment screw and the at least one engager defining a gap;
wherein the at least one engager expands during a heating of the unit such that a height of the gap decreases, wherein when the height of the gap is zero, the compressive force is applied to the laminae.
